(19) United States
(12) Patent Application Publication
(10) Pub. No.: US 2017/0242305 A1
(43) Pub. Date: Aug. 24, 2017

(54) LIQUID CRYSTAL DISPLAY PANEL

(71) Applicant: AU OPTRONICS CORPORATION, Hsin-chu (TW)

(72) Inventor: Pei-Chun LIAO, Hsin-chu (TW)

(21) Appl. No.: 15/267,359

(22) Filed: Sep. 16, 2016

(30) Foreign Application Priority Data
Feb. 19, 2016 (TW) 105105036

(51) Int. Cl. G02F 1/1343; G02F 1/1333; G02F 1/1337; G02F 1/1362; G09G 3/36

(52) U.S. Cl. CPC G02F 1/134309; G02F 1/136286; G09G 3/3614; G02F 1/1337; G02F 1/133345; G02F 1/13439; G09G 3/3688; G09G 3/3677; G02F 2201/123; G02F 2201/121; G02F 2001/136218; G02F 2001/134372; G02F 2001/134318; G02F 1/1368

(57) ABSTRACT

A liquid crystal display panel includes multiple pixel units. At least one pixel unit includes first and second substrates, a scan line, data lines, first and second pixel structures, a shielding electrode layer, and a negative liquid crystal layer. The first pixel structure includes a first active device, a first pixel electrode, and a first common electrode. The second pixel structure includes a second active device, a second pixel electrode, and a second common electrode. The first common electrode and the second common electrode are provided with different voltages. One of the first pixel electrode and the first common electrode and one of the second pixel electrode and the second common electrode respectively include a frame and two strip electrodes. The frame has two sides, and two ends of each strip electrode are respectively connected to the two sides. The shielding electrode layer overlaps with the data lines.

### TECHNICAL FIELD

The present invention relates to a display panel, and more particularly to a liquid crystal display panel.

### BACKGROUND

In recent years, environmental awareness increases, and a display panel having desirable characteristics such as low logic power, no radiation, a wide viewing angle, and high picture quality already becomes mainstream in the market. For a requirement of a wide viewing angle, a fringe field switching (FFS) liquid crystal display panel becomes one of the commonly used display panels at present.

In the FFS liquid crystal display panel, to prevent liquid crystal molecules above a data line from being affected by a data voltage to generate an unexpected twist, which further causes a light leakage problem, a common electrode is usually used to shield the data line. A driving manner of common voltage swing (Com-Swing) is one of the technologies that are generally used to reduce logic power of a display panel. However, when the driving manner of common voltage swing is used to achieve objectives of reducing logic power and power consumption, in the FFS liquid crystal display panel, a common electrode configured to shield a data line cannot be used to prevent liquid crystal molecules above the data line from an unexpected twist, and therefore a light leakage problem still exists.

Therefore, developing an FFS liquid crystal display panel having low logic power and no light leakage problem is substantially one of the objectives that the developers intend to achieve.

### SUMMARY

The present invention provides a liquid crystal display panel, where the liquid crystal display panel is an FFS liquid crystal display panel having low logic power, a fast response speed, and no light leakage problem.

The liquid crystal display panel of the present invention includes a plurality of pixel units. At least one pixel unit of the pixel units includes a first substrate, a scan line, a first data line, a second data line, a third data line, a first pixel structure, a second pixel structure, a shielding electrode layer, a second substrate, and a negative liquid crystal layer. The scan line, the first data line, the second data line, and the third data line are configured on the first substrate. The first pixel structure is located between the first data line and the second data line, is electrically connected to the scan line and the first data line, and includes a first active device, a first pixel electrode, and a first common electrode. The first pixel electrode is electrically connected to the first active device, and the first common electrode and the first pixel electrode are structurally separated. The second pixel structure is located between the second data line and the third data line, is electrically connected to the scan line and the second data line, and includes a second active device, a second pixel electrode, and a second common electrode. The second pixel structure and the first pixel structure are configured to have different polarities. The second pixel electrode is electrically connected to the second active device, and the second common electrode and the second pixel electrode are structurally separated. The first common electrode and the second common electrode are configured to be provided with different voltages. One of the first pixel electrode and the first common electrode and one of the second pixel electrode and the second common electrode respectively include a frame and two strip electrodes. The frame has two sides disposed along an extending direction of the first data line and the second data line, and two ends of each strip electrode are respectively connected to the two sides. The shielding electrode layer corresponds to the first data line, the second data line, and the third data line, and overlaps with the first data line, the second data line, and the third data line. The second substrate is located opposite the first substrate. The negative liquid crystal layer is disposed between the first substrate and the second substrate.

Based on the above, in the liquid crystal display panel of the present invention, a second pixel structure and a first pixel structure are configured to have different polarities. A first common electrode and a second common electrode are configured to be provided with different voltages. One of a first pixel electrode and the first common electrode and one of a second pixel electrode and the second common electrode respectively includes a frame and two strip electrodes. Two ends of each strip electrode are respectively connected to two sides, disposed along an extending direction of data lines, of the frame. A shielding electrode layer corresponds to the data lines and overlaps with the data lines. And a negative liquid crystal layer is disposed between the first substrate and the second substrate. Therefore, the liquid crystal display panel can at the same time have advantages including low logic power, fast response speed, and no light leakage problem.

To make the foregoing features and advantages of the present invention more comprehensible, detailed description is provided below with reference to the implementation manners and the accompanying drawings.

### BRIEF DESCRIPTION OF THE DRAWINGS

FIG. 1 is a schematic top view of a liquid crystal display panel according to a first implementation manner of the present invention;

FIG. 2 is a schematic sectional view along a sectional line I-I′ in FIG. 1;

FIG. 3A and FIG. 3B are respectively a schematic top view of a variant implementation manner of an electrode configuration;

FIG. 4 is a schematic top view of a liquid crystal display panel according to a second implementation manner of the present invention;

FIG. 5 is a schematic sectional view along a sectional line I-I′ in FIG. 4;

FIG. 6 is a schematic top view of a liquid crystal display panel according to a third implementation manner of the present invention;

FIG. 7 is a schematic sectional view along a sectional line I-I′ in FIG. 6;

FIG. 8 is a schematic top view of a liquid crystal display panel according to a fourth implementation manner of the present invention;

FIG. 9 is a schematic sectional view along a sectional line I-I′ in FIG. 8;

FIG. 10 is a schematic top view of a liquid crystal display panel according to a fifth implementation manner of the present invention;

FIG. 11 is a schematic sectional view along a sectional line I-I′ in FIG. 10;

FIG. 12 is a schematic top view of a liquid crystal display panel according to a sixth implementation manner of the present invention;

FIG. 13 is a schematic sectional view along a sectional line I-I′ in FIG. 12;

FIG. 14 is a schematic top view of a liquid crystal display panel according to a seventh implementation manner of the present invention; and

FIG. 15 is a schematic sectional view along a sectional line I-I′ in FIG. 14.

### DETAILED DESCRIPTION

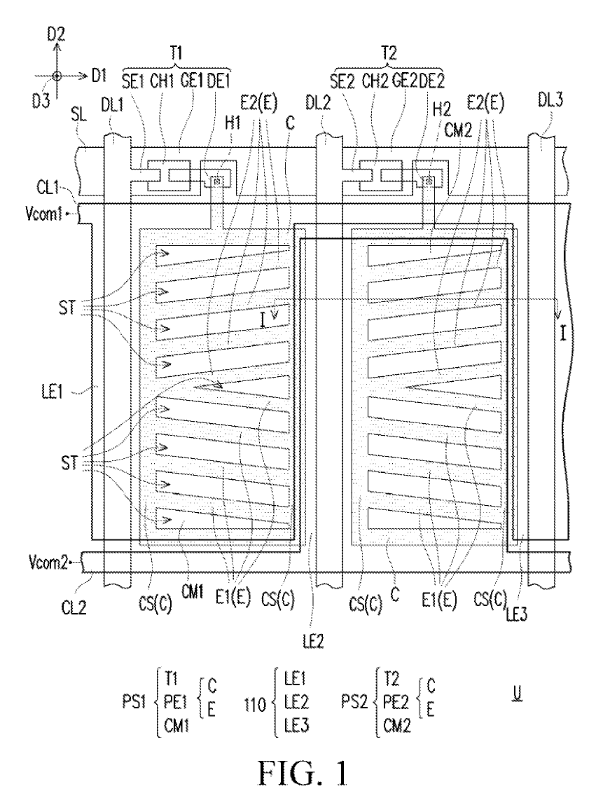

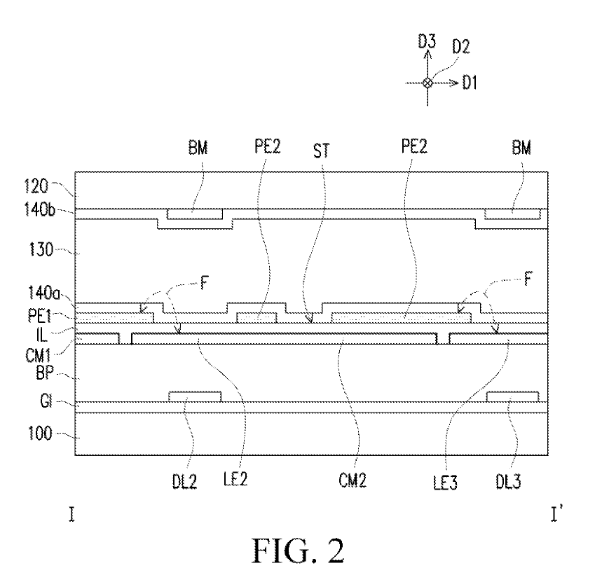

FIG. 1 is a schematic top view of a liquid crystal display panel according to a first implementation manner of the present invention. FIG. 2 is a schematic sectional view along a sectional line I-I′ in FIG. 1.

Referring to both FIG. 1 and FIG. 2, the liquid crystal display panel in this implementation manner includes a plurality of pixel units U. Specifically, a pixel unit U includes a first substrate 100, a scan line SL, a first data line DL1, a second data line DL2, a third data line DL3, a first pixel structure PS1, a second pixel structure PS2, a shielding electrode layer 110, a second substrate 120, and a negative liquid crystal layer 130. For ease of description, members of the parts such as the first substrate 100, the second substrate 120, and the negative liquid crystal layer 130 are omitted in FIG. 1, and FIG. 1 only shows one pixel unit U. It should be noted that in this implementation manner, the third data line DL3 in FIG. 1 is the first data line DL1 in another pixel unit U (not shown).

A material of the first substrate 100 may be glass, quartz or an organic polymer. The second substrate 120 is located opposite to the first substrate 100. A material of the second substrate 120 may be glass, quartz or an organic polymer.

The negative liquid crystal layer 130 is disposed between the first substrate 100 and the second substrate 120. The negative liquid crystal layer 130 includes multiple negative liquid crystal molecules (not shown).

The scan line SL, the first data line DL1, the second data line DL2, and the third data line DL3 are configured on the first substrate 100. An extending direction of the scan line SL is different from an extending direction of the first data line DL1, the second data line DL2, and the third data line DL3. Preferably, the extending direction of the scan line SL is perpendicular to the extending direction of the first data line DL1, the second data line DL2, and the third data line DL3. Specifically, in this implementation manner, the extending direction of the scan line SL is a first direction D1, and the extending direction of the first data line DL1, the second data line DL2, and the third data line DL3 is a second direction D2, where the first direction D1 and the second direction D2 are perpendicular.

In addition, the scan line SL is located on a film layer different from a film layer on which the first data line DL1, the second data line DL2, and the third data line DL3 are located, and a gate insulation layer GI (described in detail hereinafter) is sandwiched between the scan line SL and the first data line DL1, the second data line DL2, and the third data line DL3. Additionally, based on consideration of conductivity, a metal material is generally used for the scan line SL and the first data line DL1, the second data line DL2, and the third data line DL3. However, the present invention is not limited thereto. According to another implementation manner, for the scan line SL and the first data line DL1, the second data line DL2, and the third data line DL3, another conductive material such as an alloy, a nitride of a metal material, an oxide of a metal material, and a nitrogen oxide of a metal material, or a stacked layer of a metal material and another conductive material above may also be used.

The first pixel structure PS1 is located between the first data line DL1 and the second data line DL2, and the scan line SL is electrically connected to the first data line DL1. The second pixel structure PS2 is located between the second data line DL2 and the third data line DL3, and the scan line SL is electrically connected to the second data line DL2, where the first pixel structure PS1 and the second pixel structure PS2 are configured to have different polarities. Generally, from each data line, a corresponding data voltage or signal is input to a corresponding pixel structure, to enable each pixel structure to present a required display effect. That is, in this implementation manner, voltages received by the first data line DL1 and the second data line DL2 have different polarities. For example, in an implementation manner, when the foregoing first pixel structure PS1 and second pixel structure PS2 are being operated or driven, in a same time period (time period), the first data line DL1 receives a negative-polarity voltage, whereas the second data line DL2 receives a positive-polarity voltage. Herein, the negative-polarity voltage is defined as a case in which a voltage on a data line is substantially less than a voltage on a corresponding common electrode, whereas the positive-polarity voltage is defined as a case in which a voltage on a data line is substantially greater than a voltage on a corresponding common electrode.

Specifically, in this implementation manner, the first pixel structure PS1 includes a first active device T1, a first pixel electrode PE1, and a first common electrode CM1, and the second pixel structure PS2 includes a second active device T2, a second pixel electrode PE2, and a second common electrode CM2.

In this implementation manner, the first active device T1 may be a bottom gate thin film transistor or a top gate thin film transistor, and includes a gate GE1, a channel layer CH1, a drain DE1, and a source SE1, and the second active device T2 may be a bottom gate thin film transistor or a top gate thin film transistor, and includes a gate GE2, a channel layer CH2, a drain DE2, and a source SE2.

The gate GE1 and the gate GE2 are both continuous conductive patterns with the scan line SL, and it represents that the gate GE1 and the gate GE2 are both electrically connected to the scan line SL. In this implementation manner, a partial area of the scan line SL is used as the gate GE1 and the gate GE2. The channel layer CH1 is located above the gate GE1, and the channel layer CH2 is located above the gate GE2. The source SE1 and the drain DE1 are located above the channel layer CH1, and the source SE2 and the drain DE2 are located above the channel layer CH2. The source SE1 and the first data line DL1 are a continuous conductive pattern, and it represents that the source SE1 and the first data line DL1 are electrically connected to each other. The source SE2 and the second data line DL2 are a continuous conductive pattern, and it represents that the source SE2 and the second data line DL2 are electrically connected to each other. From another perspective, in this implementation manner, when a control signal is input in the scan line SL, the scan line SL and the gate GE1 and the gate GE2 are electrically turned on. When a control signal is input in the first data line DL1, the first data line DL1 and the source SE1 are electrically turned on. When a control signal is input in the second data line DL2, the second data line DL2 and the source SE2 are electrically turned on.

Additionally, in this implementation manner, a gate insulation layer GI is further disposed respectively between the gate GE1 and the channel layer CH1 and between the gate GE2 and the channel layer CH2, where the gate insulation layer GI is integrally formed on the first substrate 100 and covers the gate GE1 and the gate GE2, and a protection layer BP is further covered above the first active device T1 and the second active device T2, so as to protect the first active device T1 and the second active device T2. Materials of the gate insulation layer GI and the protection layer BP may be inorganic materials, organic materials or a combination thereof, where the inorganic material is, for example, silicon oxide, silicon nitride, silicon nitrogen oxide, or a stacked layer of at least two materials above; and the organic material is a polymeric material such as polyimide resin, epoxy resin or acrylic resin.

The first pixel electrode PE1 is electrically connected to the first active device T1, and the second pixel electrode PE2 is electrically connected to the second active device T2. Specifically, in this implementation manner, the first pixel electrode PE1 is electrically connected to the drain DE1 of the first active device T1 through a contact window H1, and the second pixel electrode PE2 is electrically connected to the drain DE2 of the second active device T2 through a contact window H2. The first pixel electrode PE1 and the second pixel electrode PE2 are, for example, transparent conductive layers, and materials of the first pixel electrode PE1 and the second pixel electrode PE2 include metal oxide conductive materials, for example, indium tin oxide, indium zinc oxide, aluminum tin oxide, aluminum zinc oxide, indium germanium zinc oxide, or another suitable oxide, or a stacked layer of at least two above.

In this implementation manner, the first pixel electrode PE1 and the second pixel electrode PE2 respectively include a frame C and multiple strip electrodes E. The frame C has two sides CS disposed along an extending direction of the first data line DL1 and the second data line DL2. Specifically, the frame C has the two sides CS disposed parallel to the first data line DL1, the second data line DL2, and the third data line DL3. Two ends of a strip electrode E are respectively connected to the two sides CS. Further specifically, the strip electrode E includes a first strip electrode E1 and a second strip electrode E2, where an extending direction of the first strip electrode E1 and an extending direction of the second strip electrode E2 intersect with each other. That is, in this implementation manner, the first pixel electrode PE1 and the second pixel electrode PE2 are in a layout design in the shape of the symbol “=”. In such a manner, according to the layout design of the first pixel electrode PE1 and the second pixel electrode PE2, when the liquid crystal display panel is in a display state, an electric field direction inside the liquid crystal display panel has substantially an included angle of 60 degrees to 90 degrees from the first direction D1. Additionally, in this implementation manner, a slit ST exists between two adjacent strip electrodes E or between the frame C and a strip electrode E.

Additionally, although in this implementation manner, both the first pixel electrode PE1 and the second pixel electrode PE2 include eight strip electrodes E, four first strip electrodes E1, and four second strip electrodes E2, the present invention is not limited thereto. In another implementation manner, according to an actual need, a person of ordinary skill in the art may adjust quantities of the strip electrodes E, the first strip electrodes E1, and the second strip electrodes E2, and as long as the first pixel electrode PE1 and the second pixel electrode PE2 at least have two strip electrodes E, such a case falls within the scope of the present invention.

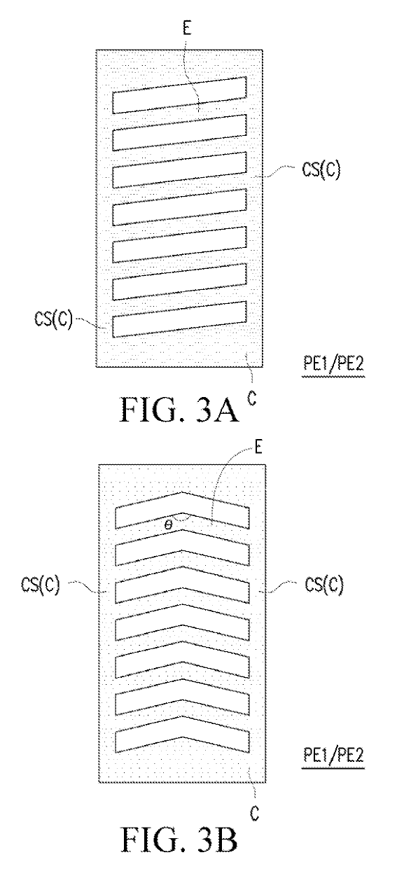

Additionally, although in this implementation manner, the strip electrodes E include the first strip electrode E1 and the second strip electrode E2, and the extending direction of the first strip electrode E1 and the extending direction of the second strip electrode E2 intersect with each other, the conformation of the first pixel electrode PE1 and the second pixel electrode PE2 is not limited thereto, and as long as the first pixel electrode PE1 and the second pixel electrode PE2 have a configuration in the shape of the symbol “=”, such a case falls within the scope of the present invention. For example, in another implementation manner, according to an actual need, the strip electrodes E may also be linear strip electrodes, and have the same extending direction, as shown in FIG. 3A; or each strip electrode E may also have a bending portion and two connecting portions connected to the bending portion, where an included angle θ of the bending portion is between 120 degrees and 180 degrees, as shown in FIG. 3B.

The first common electrode CM1 and the first pixel electrode PE1 are structurally separated from each other, and the second common electrode CM2 and the second pixel electrode PE2 are structurally separated from each other. Specifically, in this implementation manner, an inter-layer insulation layer IL is further disposed respectively between the first common electrode CM1 and the first pixel electrode PE1 and between the second common electrode CM2 and the second pixel electrode PE2, so that the first common electrode CM1 and the first pixel electrode PE1 are structurally separated from each other, and the second common electrode CM2 and the second pixel electrode PE2 are structurally separated from each other. Further specifically, in this implementation manner, the first pixel electrode PE1 and the second pixel electrode PE2 are both disposed above the inter-layer insulation layer IL, that is, the first common electrode CM1 and the second common electrode CM2 are correspondingly disposed below the first pixel electrode PE1 and the second pixel electrode PE2.

The first common electrode CM1 and the second common electrode CM2 are, for example, transparent conductive layers, and materials of the first common electrode CM1 and the second common electrode CM2 include metal oxide conductive materials, for example, indium tin oxide, indium zinc oxide, aluminum tin oxide, aluminum zinc oxide, indium germanium zinc oxide, or another suitable oxide, or a stacked layer of at least two above. An material of the inter-layer insulation layer IL may be an inorganic material, an organic material or a combination thereof, where the inorganic material is, for example, silicon oxide, silicon nitride, silicon nitrogen oxide, or a stacked layer of at least two materials above; and the organic material is a polymeric material such as polyimide resin, epoxy resin or acrylic resin.

Additionally, in this implementation manner, the first common electrode CM1 and the second common electrode CM2 are configured to be provided with different voltages. That is, the voltage on the first common electrode CM1 is different from the voltage on the second common electrode CM2. Specifically, when the first pixel structure PS1 and the second pixel structure PS2 are being operated or driven, within a same time period, the voltage received by the first common electrode CM1 is different from the voltage received by the second common electrode CM2. That is, for the liquid crystal display panel in this implementation manner, a driving manner of common voltage swing (Com-Swing) is used.

Additionally, in this implementation manner, when the liquid crystal display panel is in a display state, an edge electric field is generated respectively between the first pixel electrode PE1 and the first common electrode CM1 and between the second pixel electrode PE2 and the second common electrode CM2, and an electric field direction of the edge electric field is substantially perpendicular to the first direction D1. Specifically, in this implementation manner, the negative liquid crystal molecules (not shown) in the negative liquid crystal layer 130 is mainly driven by using the edge electric field. Further specifically, the liquid crystal display panel in this implementation manner is an FFS liquid crystal display panel.

The shielding electrode layer 110 includes a first shielding electrode LE1, a second shielding electrode LE2, and a third shielding electrode LE3, where the first shielding electrode LE1 corresponds to the first data line DL1 and overlaps with the first data line DL1, the second shielding electrode LE2 corresponds to the second data line DL2 and overlaps with the second data line DL2, and the third shielding electrode LE3 corresponds to the third data line DL3 and overlaps with the third data line DL3. That is, in this implementation manner, the shielding electrode layer 110 corresponds to the first data line DL1, the second data line DL2, and the third data line DL3, and overlaps with the first data line DL1, the second data line DL2, and the third data line DL3.

Additionally, in this implementation manner, the first shielding electrode LE1, the first common electrode CM1, and the third shielding electrode LE3 are connected to each other, to form a common electrode line CL1, whereas the second shielding electrode LE2 and the second common electrode CM2 are connected to each other, to form a common electrode line CL2. That is, in this implementation manner, the first shielding electrode LE1, the third shielding electrode LE3, and the first common electrode CM1 are configured to be provided with a same voltage, and the second shielding electrode LE2 and the second common electrode CM2 are configured to be provided with a same voltage. Furthermore, as discussed above, because the first common electrode CM1 and the second common electrode CM2 are configured to be provided with different voltages, the common electrode line CL1 and the common electrode line CL2 are also configured to be provided with different voltages, and the common electrode line CL1 and the common electrode line CL2 are structurally separated from each other. Additionally, in this implementation manner, the common electrode line CL1 is electrically connected to an alternating current common voltage Vcom1, and the common electrode line CL2 is electrically connected to an alternating current common voltage Vcom2.

From another perspective, in this implementation manner, the first shielding electrode LE1, the first common electrode CM1, and the third shielding electrode LE3 are a continuous conductive pattern, so that the first shielding electrode LE1 and the third shielding electrode LE3 have materials the same as that of the first common electrode CM1; the second shielding electrode LE2 and the second common electrode CM2 are a continuous conductive pattern, so that the second shielding electrode LE2 has a material the same as that of the second common electrode CM2.

It should be noted that, as discussed above, in the liquid crystal display panel in this implementation manner, the shielding electrode layer 110 that overlaps with the first data line DL1, the second data line DL2, and the third data line DL3 and receives a common voltage is disposed; therefore, a light leakage problem caused when data voltages on the first data line DL1, the second data line DL2, and the third data line DL3 affect the negative liquid crystal molecules (not shown) in the negative liquid crystal layer 130 is avoided.

In this implementation manner, each pixel unit U may further include a first alignment film 140a and a second alignment film 140b, so as to provide an anchoring force to the negative liquid crystal molecules (not shown) in the negative liquid crystal layer 130, to keep the negative liquid crystal molecules in an arrangement state parallel to the first substrate 100 and the second substrate 120. That is, regardless of whether the liquid crystal display panel is in a display state, the negative liquid crystal molecules is arranged in manner of being parallel to the first substrate 100 and the second substrate 120. Specifically, in this implementation manner, the first alignment film 140a is configured on the first substrate 100, and is located between the first substrate 100 and the negative liquid crystal layer 130, and the second alignment film 140b is configured on the second substrate 120, and is located between the second substrate 120 and the negative liquid crystal layer 130.

Additionally, in this implementation manner, the first alignment film 140a and the second alignment film 140b have a same alignment direction, so that the negative liquid crystal molecules (not shown) in the negative liquid crystal layer 130 are substantially aligned along the alignment direction. Specifically, an alignment direction of the first alignment film 140a and an alignment direction of the second alignment film 140b are substantially perpendicular to the first direction D1. That is, in this implementation manner, without being driven by an electric field, the negative liquid crystal molecules (not shown) in the negative liquid crystal layer 130 are kept in an arrangement state in which long axes are substantially perpendicular to the first direction D1, that is, the long axes are substantially parallel to the second direction D2.

Generally, when an electric field is applied on two ends of the negative liquid crystal molecules, short axes of the negative liquid crystal molecules are arranged along a direction of the electric field. As discussed above, by means of the layout design of the first pixel electrode PE1 and the second pixel electrode PE2, when the liquid crystal display panel is in a display state, an electric field direction inside the liquid crystal display panel has substantially an included angle of 60 degrees to 90 degrees from the first direction D1. In this implementation manner, the first alignment film 140a and the second alignment film 140b are disposed in such a manner, and when the liquid crystal display panel is in a display state, negative liquid crystal molecules whose long axes are originally substantially perpendicular to the first direction D1 are twisted, so as to enable short axes of the negative liquid crystal molecules to be arranged along an electric field direction perpendicular to the first direction D1.

Additionally, in this implementation manner, each pixel unit U further includes a black matrix layer BM, configured to shield elements and wiring, for example, the scan line SL, the first data line DL1, the second data line DL2, the third data line DL3, the first active device T1, the second active device T2, that are intended to be invisible to a user. A material of the black matrix layer BM may be, for example, black resin or black matrix metal (for example, chromium), that has relatively low reflectivity.

It should be described that, for the liquid crystal display panel in this implementation manner, by means of the architecture shown in FIG. 1 and FIG. 2, when the first pixel structure PS1 and the second pixel structure PS2 are switched to zero grayscale, an electric field is generated between the first pixel electrode PE1 and the shielding electrode layer 110, and between the second pixel electrode PE2 and the shielding electrode layer 110. Specifically, referring to FIG. 2, in this implementation manner, an electric field F is generated between the second shielding electrode LE2 and the first pixel electrode PE1, and an electric field F is generated between the third shielding electrode LE3 and the second pixel electrode PE2. Further specifically, the electric field F has electric field directions of the first direction D1 and a third direction D3.

For example, referring to FIG. 2, in an implementation manner, when the first pixel structure PS1 and the second pixel structure PS2 are switched to zero grayscale, the first pixel electrode PE1 receives a negative-polarity voltage of 5.5 V, the second pixel electrode PE2 receives a positive-polarity voltage of 0.5 V, the first common electrode CM1 and the third shielding electrode LE3 receive a common voltage of 6 V, and the second common electrode CM2 and the second shielding electrode LE2 receive a common voltage of 0 V, an electric field F is generated between the second shielding electrode LE2 on which the voltage is 0 V and the first pixel electrode PE1 on which the voltage is 5.5 V, and an electric field F is generated between the third shielding electrode LE3 on which the voltage is 6 V and the second pixel electrode PE2 on which the voltage is 0.5 V.

However, it should be further described that, although when the first pixel structure PS1 and the second pixel structure PS2 are switched to zero grayscale, an electric field F is generated respectively between the second shielding electrode LE2 and the first pixel electrode PE1 and between the third shielding electrode LE3 and the second pixel electrode PE2, the electric field F cannot affect the negative liquid crystal molecules (not shown) in the negative liquid crystal layer 130, and therefore an unexpected twist does not occur; the reason is as follows. As discussed above, when the first pixel structure PS1 and the second pixel structure PS2 are switched to zero grayscale (that is, the negative liquid crystal molecules are not driven by an electric field), the negative liquid crystal molecules are kept in an arrangement state in which long axes are substantially parallel to the second direction D2, and in this state, two short axes of the negative liquid crystal molecules are respectively parallel to the first direction D1 and the third direction D3, that is, two short axes of the negative liquid crystal molecules are respectively parallel to an electric field direction of the electric field F. Therefore, in this case, the negative liquid crystal molecules absolutely do not twist due to the electric field F. In such a manner, the liquid crystal display panel in this implementation manner does not have a light leakage problem.

For the liquid crystal display panel in this implementation manner, as discussed above, when the first pixel structure PS1 and the second pixel structure PS2 are switched to zero grayscale, in addition to alignment forces provided by the first alignment film 140a and the second alignment film 140b, the electric field F respectively generated between the second shielding electrode LE2 and the first pixel electrode PE1 and between the third shielding electrode LE3 and the second pixel electrode PE2 also enables the negative liquid crystal molecules to be arranged along alignment directions of the first alignment film 140a and the second alignment film 140b.

That is, in this implementation manner, the shielding electrode layer 110 includes the first shielding electrode LE1, the second shielding electrode LE2, and the third shielding electrode LE3 that are disposed corresponding to the first data line DL1, the second data line DL2, and the third data line DL3, so that when the first pixel structure PS1 and the second pixel structure PS2 are switched to zero grayscale, the electric field F respectively generated between the first pixel electrode PE1 and the shielding electrode layer 110 and between the second pixel electrode PE2 and the shielding electrode layer 110 does not cause a light leakage problem, and instead, helps negative liquid crystal molecules on edges, near the second shielding electrode LE2, of the first pixel electrode PE1 and negative liquid crystal molecules on edges, near the third shielding electrode LE3, of the second pixel electrode PE2 twist back to an initial state, thereby improving a response speed and reducing a response time.

Additionally, as discussed above, for the liquid crystal display panel in this implementation manner, a driving manner of common voltage swing is used, and therefore, a logic power of the liquid crystal display panel can be reduced. However, it should be similarly described that, when a same logic power is used, as compared with a conventional liquid crystal display panel in which the driving manner of common voltage swing is not used, enable voltages equivalently perceived by the negative liquid crystal molecules in the liquid crystal display panel in this implementation manner are relatively high, and therefore, negative liquid crystal molecules having relatively low viscosity can be selected to improve a response speed and reduce a response time. That is, the liquid crystal display panel in this implementation manner can release liquid crystal parameters by using a suitable logic power to achieve objectives of improving a response speed and reducing a response time, and offset a disadvantage that the negative liquid crystal molecules have a long response time.

In conclusion, in this implementation manner, the liquid crystal display panel is an FFS negative liquid crystal display panel, a first pixel structure PS1 and a second pixel structure PS2 are configured to have different polarities, a first common electrode CM1 and a second common electrode CM2 are configured to be provided with different voltages, a first pixel electrode PE1 and a second pixel electrode PE2 have a configuration in the shape of the symbol “=”, a shielding electrode layer 110 overlaps with a first data line DL1, a second data line DL2 and a third data line DL3, and alignment directions of a first alignment film 140a and a second alignment film 140b are substantially perpendicular to an extending direction of a scan line SL, so that the liquid crystal display panel can at the same time have advantages of a low logic power, a fast response speed, and no light leakage problem.

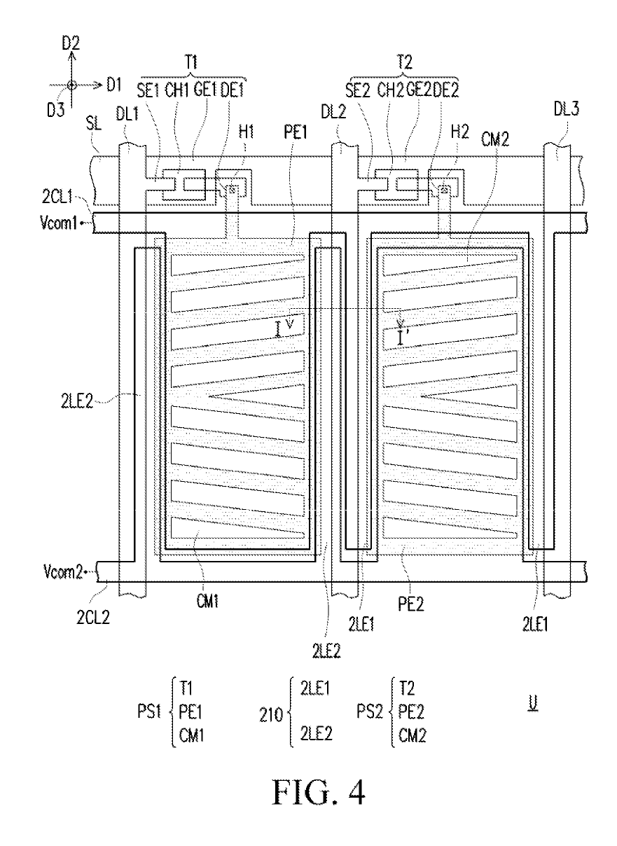

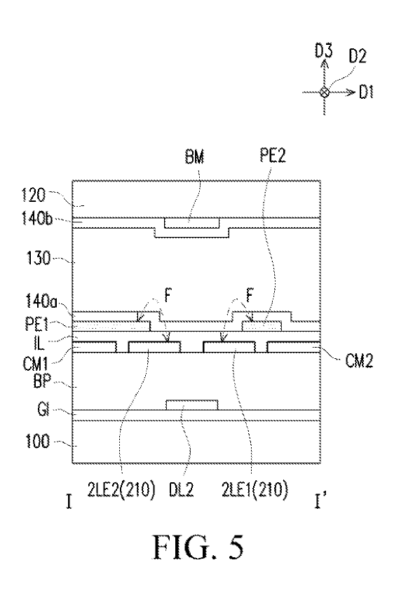

FIG. 4 is a schematic top view of a liquid crystal display panel according to a second implementation manner of the present invention. FIG. 5 is a schematic sectional view along a sectional line I-I′ in FIG. 4. Referring to both FIG. 4 and FIG. 1, the liquid crystal display panel in FIG. 4 and the liquid crystal display panel in FIG. 1 are similar, and therefore the same or similar elements are represented by using the same or similar symbols. Differences between the two are described below, and for what are the same of the two, reference may be made to the foregoing description according to the symbols in FIG. 1 and FIG. 2.

Referring to both FIG. 4 and FIG. 5, a shielding electrode layer 210 includes two first shielding electrodes 2LE1 and two second shielding electrodes 2LE2, where the two first shielding electrodes 2LE1 are respectively disposed on two sides of a second common electrode CM2 and are respectively overlapped with a second data line DL2 and a third data line DL3, and the two second shielding electrodes 2LE2 are respectively disposed on two sides of a first common electrode CM1 and are respectively overlapped with a first data line DL1 and the second data line DL2. That is, in this implementation manner, the shielding electrode layer 210 corresponds to the first data line DL1, the second data line DL2, and the third data line DL3, and overlaps with the first data line DL1, the second data line DL2, and the third data line DL3.

Additionally, in this implementation manner, the two first shielding electrodes 2LE1 and the first common electrode CM1 are connected to each other, to form a common electrode line 2CL1, and the two second shielding electrodes 2LE2 and the second common electrode CM2 are connected to each other, to form a common electrode line 2CL2. That is, in this implementation manner, the first shielding electrode 2LE1 and the first common electrode CM1 are configured to be provided with a same voltage, and the second shielding electrode 2LE2 and the second common electrode CM2 are configured to be provided with a same voltage. Furthermore, as discussed above, because the first common electrode CM1 and the second common electrode CM2 are configured to be provided with different voltages, the common electrode line 2CL1 and the common electrode line 2CL2 are configured to be provided with different voltages, and the common electrode line 2CL1 and the common electrode line 2CL2 are structurally separated from each other. Additionally, in this implementation manner, the common electrode line 2CL1 is electrically connected to an alternating current common voltage Vcom1, and the common electrode line 2CL2 is electrically connected to an alternating current common voltage Vcom2.

From another perspective, in this implementation manner, two first shielding electrodes 2LE1 and the first common electrode CM1 are a continuous conductive pattern, and therefore the first shielding electrodes 2LE1 have the same material as the first common electrode CM1; the two second shielding electrodes 2LE2 and the second common electrode CM2 are a continuous conductive pattern, and therefore the second shielding electrodes 2LE2 have the same material as the second common electrode CM2.

It should be noted that, as discussed above, in the liquid crystal display panel in this implementation manner, the shielding electrode layer 210 that overlaps with the first data line DL1, the second data line DL2, and the third data line DL3 and receives a common voltage is disposed; therefore, a light leakage problem caused when data voltages on the first data line DL1, the second data line DL2, and the third data line DL3 affect negative liquid crystal molecules (not shown) in a negative liquid crystal layer 130 is avoided.

It should be described that, for the liquid crystal display panel in this implementation manner, by means of the architecture shown in FIG. 4 and FIG. 5, when a first pixel structure PS1 and a second pixel structure PS2 are switched to zero grayscale, an electric field is respectively generated between a first pixel electrode PE1 and the shielding electrode layer 210 and between a second pixel electrode PE2 and the shielding electrode layer 210. Specifically, referring to FIG. 5, in this implementation manner, an electric field F is respectively generated between the first pixel electrode PE1 and the second shielding electrodes 2LE2 disposed on two sides of the first common electrode CM1, and an electric field F is respectively generated between the second pixel electrode PE2 and the first shielding electrodes 2LE1 disposed on two sides of the second common electrode CM2. Further specifically, the electric field F has electric field directions of a first direction D1 and a third direction D3.

For example, referring to FIG. 5, in an implementation manner, when the first pixel structure PS1 and the second pixel structure PS2 are switched to zero grayscale, the first pixel electrode PE1 receives a negative-polarity voltage of 5.5 V, the second pixel electrode PE2 receives a positive-polarity voltage of 0.5 V, the first common electrode CM1 and the first shielding electrode 2LE1 receive a common voltage of 6 V, and the second common electrode CM2 and second shielding electrode 2LE2 receive a common voltage of 0 V, an electric field F is generated between the second shielding electrode 2LE2 on which the voltage is 0 V and the first pixel electrode PE1 on which the voltage is 5.5 V, and an electric field F is generated between the first shielding electrode 2LE1 whose voltage is 6 V and the second pixel electrode PE2 whose voltage is 0.5 V.

However, it should be further described that, although when the first pixel structure PS1 and the second pixel structure PS2 are switched to zero grayscale, an electric field F is respectively generated between the first pixel electrode PE1 and second shielding electrode 2LE2, and between the second pixel electrode PE2 and first shielding electrode 2LE1, the electric field F cannot affect the negative liquid crystal molecules (not shown) in the negative liquid crystal layer 130, and therefore an unexpected twist does not occur; the reason is as follows. As discussed above, when the first pixel structure PS1 and the second pixel structure PS2 are switched to zero grayscale (that is, the negative liquid crystal molecules are not driven by an electric field), the negative liquid crystal molecules are kept in an arrangement state in which long axes are substantially parallel to a second direction D2, and two short axes of the negative liquid crystal molecules in this state are respectively parallel to the first direction D1 and the third direction D3, that is, two short axes of the negative liquid crystal molecules are respectively parallel to an electric field direction of the electric field F. Therefore, the negative liquid crystal molecules absolutely do not twist due to the electric field F. In such a manner, the liquid crystal display panel in this implementation manner does not have a light leakage problem.

For the liquid crystal display panel in this implementation manner, as discussed above, when the first pixel structure PS1 and the second pixel structure PS2 are switched to zero grayscale, in addition to alignment forces provided by a first alignment film 140a and a second alignment film 140b, the electric field F respectively generated between the first pixel electrode PE1 and second shielding electrode 2LE2 and between the second pixel electrode PE2 and first shielding electrode 2LE1 also enables the negative liquid crystal molecules to be arranged along alignment directions of the first alignment film 140a and the second alignment film 140b.

That is, in this implementation manner, the shielding electrode layer 210 includes two second shielding electrodes 2LE2 that are disposed corresponding to the first data line DL1 and the second data line DL2 located on two sides of the first pixel electrode PE1 and two first shielding electrodes 2LE1 that are disposed corresponding to the second data line DL2 and the third data line DL3 located on two sides of the second pixel electrode PE2. When the first pixel structure PS1 and the second pixel structure PS2 are switched to zero grayscale, the electric field F respectively generated between the first pixel electrode PE1 and the shielding electrode layer 210 and between the second pixel electrode PE2 and the shielding electrode layer 210 does not cause a light leakage problem, and instead, helps negative liquid crystal molecules on two edges, near the second shielding electrode 2LE2, of the first pixel electrode PE1 and negative liquid crystal molecules on two edges, near the first shielding electrode 2LE1, of the second pixel electrode PE2 twist back to an initial state, thereby improving a response speed and reducing a response time.

Additionally, as discussed above, for the liquid crystal display panel in this implementation manner, a driving manner of common voltage swing is used, and therefore, a logic power of the liquid crystal display panel can be reduced. However, it should be similarly described that, when a same logic power is used, as compared with a conventional liquid crystal display panel in which the driving manner of common voltage swing is not used, enable voltages equivalently perceived by the negative liquid crystal molecules in the liquid crystal display panel in this implementation manner are relatively high, and therefore, negative liquid crystal molecules having relatively low viscosity can be selected to improve a response speed and reduce a response time. That is, the liquid crystal display panel in this implementation manner can release liquid crystal parameters by using a suitable logic power to achieve objectives of improving a response speed and reducing a response time, and offset a disadvantage that the negative liquid crystal molecules have a long response time.

In conclusion, in this implementation manner, the liquid crystal display panel is an FFS negative liquid crystal display panel, a first pixel structure PS1 and a second pixel structure PS2 are configured to have different polarities, a first common electrode CM1 and a second common electrode CM2 are configured to be provided with different voltages, a first pixel electrode PE1 and a second pixel electrode PE2 have a configuration in the shape of the symbol “=”, a shielding electrode layer 210 overlaps with a first data line DL1, a second data line DL2 and a third data line DL3, and alignment directions of a first alignment film 140a and a second alignment film 140b are substantially perpendicular to an extending direction of a scan line SL, so that the liquid crystal display panel can at the same time have advantages of a low logic power, a fast response speed, and no light leakage problem.

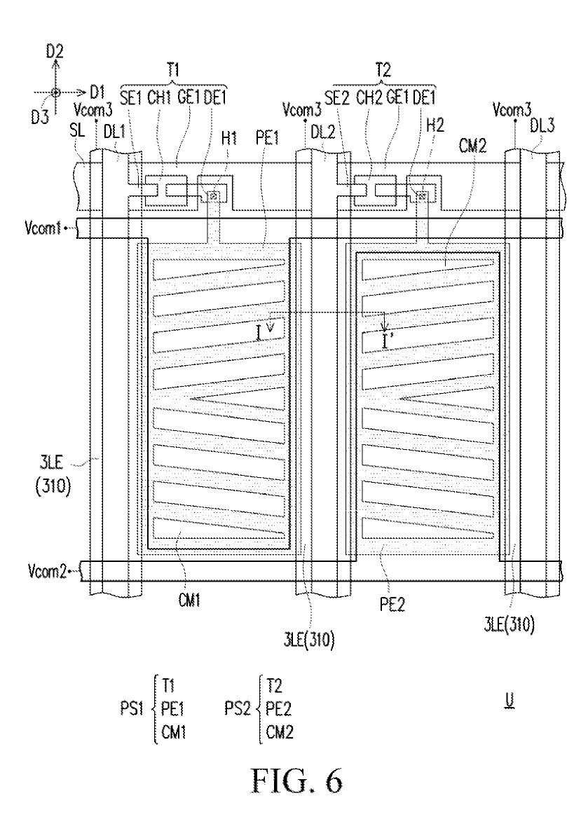

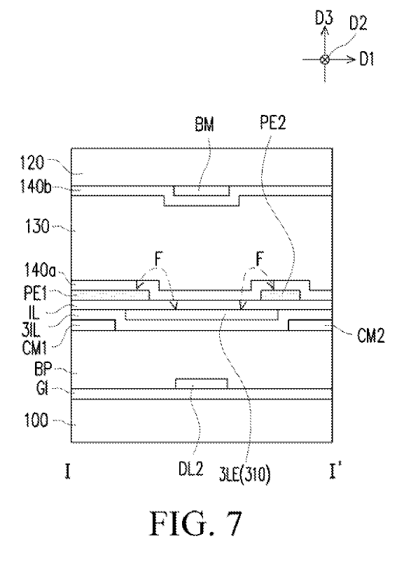

FIG. 6 is a schematic top view of a liquid crystal display panel according to a third implementation manner of the present invention. FIG. 7 is a schematic sectional view along a sectional line I-I′ in FIG. 6. Referring to both FIG. 6 and FIG. 1, the liquid crystal display panel in FIG. 6 and the liquid crystal display panel in FIG. 1 are similar, and therefore the same or similar elements are represented by using the same or similar symbols. Differences between the two are described below, and for what are the same of the two, reference may be made to the foregoing description according to the symbols in FIG. 1 and FIG. 2.

Referring to both FIG. 6 and FIG. 7, a shielding electrode layer 310 includes multiple shielding electrodes 3LE, and the shielding electrodes 3LE are respectively overlapped with a first data line DL1, a second data line DL2, and a third data line DL3. That is, in this implementation manner, the shielding electrode layer 310 corresponds to the first data line DL1, the second data line DL2, and the third data line DL3, and overlaps with the first data line DL1, the second data line DL2, and the third data line DL3. Additionally, the shielding electrode layer 310 is, for example, a transparent conductive layer, and a material of the shielding electrode layer 310 includes a metal oxide conductive material, for example, indium tin oxide, indium zinc oxide, aluminum tin oxide, aluminum zinc oxide, indium germanium zinc oxide, or another suitable oxide, or a stacked layer of at least two above.

In this implementation manner, the shielding electrodes 3LE are structurally separated from a first common electrode CM1 and a second common electrode CM2. Specifically, in this implementation manner, an inter-layer insulation layer 3IL is further disposed respectively between the shielding electrode 3LE and the first common electrode CM1 and between the shielding electrode 3LE and the second common electrode CM2, so that the shielding electrodes 3LE are structurally separated from the first common electrode CM1 and the second common electrode CM2.

Additionally, in this implementation manner, the shielding electrodes 3LE, the first common electrode CM1, and the second common electrode CM2 are configured to be provided with different voltages, and the voltages on the shielding electrodes 3LE are between the voltage on the first common electrode CM1 and the voltage on the second common electrode CM2. That is, in this implementation manner, the voltage on the shielding electrode 3LE, the voltage on the first common electrode CM1, and the voltage on the second common electrode CM2 are all different from each other. For example, in an implementation manner, the voltage on the first common electrode CM1 is 6 V, the voltage on the second common electrode CM2 is 0 V, and the voltage on the shielding electrode 3LE is 3 V. From another perspective, in this implementation manner, the first common electrode CM1 is electrically connected to an alternating current common voltage Vcom1, the second common electrode CM2 is electrically connected to an alternating current common voltage Vcom2, and the shielding electrode 3LE is electrically connected to a direct current common voltage Vcom3, where the alternating current common voltage Vcom1, the alternating current common voltage Vcom2, and the direct current common voltage Vcom3 are all different from each other.

It should be noted that, as discussed above, in the liquid crystal display panel in this implementation manner, the shielding electrode layer 310 that overlaps with the first data line DL1, the second data line DL2, and the third data line DL3 and receives the direct current common voltage Vcom3 is disposed; therefore, a light leakage problem caused when data voltages on the first data line DL1, the second data line DL2, and the third data line DL3 affect negative liquid crystal molecules (not shown) in a negative liquid crystal layer 130 is avoided.

It should be described that, for the liquid crystal display panel in this implementation manner, by means of the architecture shown in FIG. 6 and FIG. 7, when a first pixel structure PS1 and a second pixel structure PS2 are switched to zero grayscale, an electric field is respectively generated between a first pixel electrode PE1 and the shielding electrode layer 310, and between a second pixel electrode PE2 and the shielding electrode layer 310. Specifically, referring to FIG. 7, in this implementation manner, an electric field F is respectively generated between each shielding electrode 3LE and the adjacent first pixel electrode PE1 and second pixel electrode PE2. Further specifically, the electric field F has electric field directions of a first direction D1 and a third direction D3.

For example, referring to FIG. 7, in an implementation manner, when the first pixel structure PS1 and the second pixel structure PS2 are switched to zero grayscale, the first pixel electrode PE1 receives a negative-polarity voltage of 5.5 V, the second pixel electrode PE2 receives a positive-polarity voltage of 0.5 V, the first common electrode CM1 receives a common voltage of 6 V, the second common electrode CM2 receives a common voltage of 0 V, and the shielding electrode 3LE receives a common voltage of 3 V, an electric field F is generated between the shielding electrode 3LE on which the voltage is 3 V and the first pixel electrode PE1 on which the voltage is 5.5 V, and an electric field F is also generated between the shielding electrode 3LE on which the voltage is 3 V and the second pixel electrode PE2 on which the voltage is 0.5 V.

However, it should be further described that, although when the first pixel structure PS1 and the second pixel structure PS2 are switched to zero grayscale, an electric field F is respectively generated between each shielding electrode 3LE and the adjacent first pixel electrode PE1 and second pixel electrode PE2, the electric field F cannot affect the negative liquid crystal molecules (not shown) in the negative liquid crystal layer 130, and therefore an unexpected twist does not occur; the reason is as follows. As discussed above, when the first pixel structure PS1 and the second pixel structure PS2 are switched to zero grayscale (that is, the negative liquid crystal molecules are not driven by an electric field), the negative liquid crystal molecules are kept in an arrangement state in which long axes are substantially parallel to a second direction D2, and two short axes of the negative liquid crystal molecules in this state are respectively parallel to the first direction D1 and the third direction D3, that is, two short axes of the negative liquid crystal molecules are respectively parallel to an electric field direction of the electric field F. Therefore, the negative liquid crystal molecules absolutely do not twist due to the electric field F. In such a manner, the liquid crystal display panel in this implementation manner does not have a light leakage problem.

For the liquid crystal display panel in this implementation manner, as discussed above, when the first pixel structure PS1 and the second pixel structure PS2 are switched to zero grayscale, in addition to alignment forces provided by a first alignment film 140a and a second alignment film 140b, an electric field F respectively generated between the shielding electrode 3LE and the first pixel electrode PE1 and between the shielding electrode 3LE and the second pixel electrode PE2 also enables the negative liquid crystal molecules to be arranged along alignment directions of the first alignment film 140a and the second alignment film 140b.

That is, in this implementation manner, the shielding electrode layer 310 includes shielding electrodes 3LE additionally disposed corresponding to the first data line DL1, the second data line DL2, and the third data line DL3. When the first pixel structure PS1 and the second pixel structure PS2 are switched to zero grayscale, the electric field F respectively generated between the first pixel electrode PE1 and the shielding electrode layer 310, and between the second pixel electrode PE2 and the shielding electrode layer 310 does not cause a light leakage problem, and instead, helps negative liquid crystal molecules on two edges, near the shielding electrode 3LE, of the first pixel electrode PE1 and negative liquid crystal molecules on two edges, near the shielding electrode 3LE, of the second pixel electrode PE2 twist back to an initial state, thereby improving a response speed and reducing a response time.

Additionally, as discussed above, for the liquid crystal display panel in this implementation manner, a driving manner of common voltage swing is used, and therefore, a logic power of the liquid crystal display panel can be reduced. However, it should be similarly described that, when a same logic power is used, as compared with a conventional liquid crystal display panel in which the driving manner of common voltage swing is not used, enable voltages equivalently perceived by the negative liquid crystal molecules in the liquid crystal display panel in this implementation manner are relatively high, and therefore, negative liquid crystal molecules having relatively low viscosity can be selected to improve a response speed and reduce a response time. That is, the liquid crystal display panel in this implementation manner can release liquid crystal parameters by using a suitable logic power to achieve objectives of improving a response speed and reducing a response time, and offset a disadvantage that the negative liquid crystal molecules have a long response time.

In conclusion, in this implementation manner, the liquid crystal display panel is an FFS negative liquid crystal display panel, a first pixel structure PS1 and a second pixel structure PS2 are configured to have different polarities, a first common electrode CM1 and a second common electrode CM2 are configured to be provided with different voltages, a first pixel electrode PE1 and a second pixel electrode PE2 have a configuration in the shape of the symbol “=”, a shielding electrode layer 310 overlaps with a first data line DL1, a second data line DL2 and a third data line DL3, and alignment directions of a first alignment film 140a and a second alignment film 140b are substantially perpendicular to an extending direction of a scan line SL, so that the liquid crystal display panel can at the same time have advantages of low logic power, a fast response speed, and no light leakage problem.

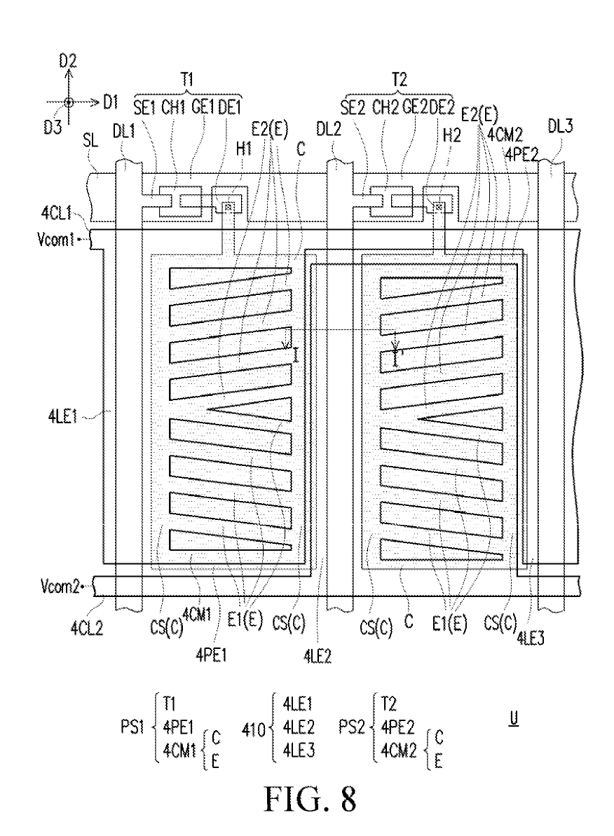

Additionally, in the first to third implementation manners above, a first pixel electrode PE1 and a second pixel electrode PE2 are both disposed above an inter-layer insulation layer IL, and the first pixel electrode PE1 and the second pixel electrode PE2 both include a strip electrode E; however, the present invention is not limited thereto. In another implementation manner, in the liquid crystal display panel, the first common electrode and the second common electrode may also be located above inter-layer insulation layer, and the first common electrode and the second common electrode respectively include a strip electrode. Detailed description is provided below with reference to FIG. 8 to FIG. 13.

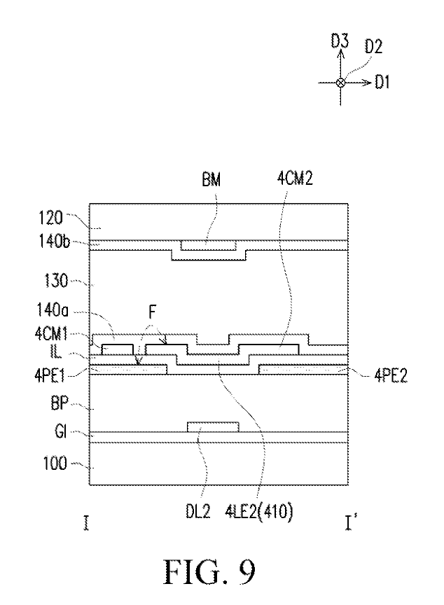

FIG. 8 is a schematic top view of a liquid crystal display panel according to a fourth implementation manner of the present invention. FIG. 9 is a schematic sectional view along a sectional line I-I′ in FIG. 8. Referring to both FIG. 8 and FIG. 1, the liquid crystal display panel in FIG. 8 and the liquid crystal display panel in FIG. 1 are similar, and therefore the same or similar elements are represented by using the same or similar symbols. Differences between the two are described below, and for what are the same of the two, reference may be made to the foregoing description according to the symbols in FIG. 1 and FIG. 2.

Referring to both FIG. 8 and FIG. 1, differences between the liquid crystal display panel in FIG. 8 and the liquid crystal display panel in FIG. 1 mainly lie in that: in the liquid crystal display panel in FIG. 8, a first pixel electrode 4PE1 and a second pixel electrode 4PE2 are respectively an electrode having a block-form pattern, and a first common electrode 4CM1 and a second common electrode 4CM2 respectively include a frame C and multiple strip electrodes E; in the liquid crystal display panel in FIG. 1, the first pixel electrode PE1 and the second pixel electrode PE2 respectively include the frame C and multiple strip electrodes E, and a first common electrode CM1 and the second common electrode CM2 are respectively an electrode having a block-form pattern. That is, in this implementation manner, the first common electrode 4CM1 and the second common electrode 4CM2 have a layout design in the shape of the symbol “=”, whereas in the first implementation manner, the first pixel electrode PE1 and the second pixel electrode PE2 have a layout design in the shape of the symbol “=”.

From another perspective, referring to both FIG. 9 and FIG. 2, in this implementation manner, the first common electrode 4CM1 and the second common electrode 4CM2 are both disposed above an inter-layer insulation layer IL, and the first pixel electrode 4PE1 and the second pixel electrode 4PE2 are correspondingly disposed below the first common electrode 4CM1 and the second common electrode 4CM2. In the first implementation manner, the first pixel electrode PE1 and the second pixel electrode PE2 are disposed above the inter-layer insulation layer IL, and the first common electrode CM1 and the second common electrode CM2 are correspondingly disposed below the first pixel electrode PE1 and the second pixel electrode PE2. That is, as discussed in the first implementation manner, in this implementation manner, when the liquid crystal display panel is in a display state, an edge electric field whose electric field direction is substantially perpendicular to a first direction D1 is respectively generated between the first common electrode 4CM1 and the first pixel electrode 4PE1, and between the second common electrode 4CM2 and the second pixel electrode 4PE2.

Furthermore, referring to FIG. 8 and FIG. 9, in this implementation manner, a shielding electrode layer 410 includes a first shielding electrode 4LE1, a second shielding electrode 4LE2, and a third shielding electrode 4LE3, where the first shielding electrode 4LE1 corresponds to a first data line DL1 and overlaps with the first data line DL1, the second shielding electrode 4LE2 corresponds to a second data line DL2 and overlaps with the second data line DL2, and the third shielding electrode 4LE3 corresponds to a third data line DL3 and overlaps with the third data line DL3. That is, in this implementation manner, the shielding electrode layer 410 corresponds to the first data line DL1, the second data line DL2, and the third data line DL3, and overlaps with the first data line DL1, the second data line DL2, and the third data line DL3.

Additionally, in this implementation manner, the first shielding electrode 4LE1, the first common electrode 4CM1 and the third shielding electrode 4LE3 are connected to each other to form a common electrode line 4CL1, whereas the second shielding electrode 4LE2 and the second common electrode 4CM2 are connected to each other to form a common electrode line 4CL2. That is, in this implementation manner, the first shielding electrode 4LE1, the third shielding electrode 4LE3, and the first common electrode 4CM1 are configured to be provided with a same voltage, and the second shielding electrode 4LE2 and the second common electrode 4CM2 are configured to be provided with a same voltage.

Furthermore, as discussed in the first implementation manner, because the first common electrode 4CM1 and the second common electrode 4CM2 are configured to be provided with different voltages, the common electrode line 4CL1 and the common electrode line 4CL2 are also configured to be provided with different voltages, and the common electrode line 4CL1 and the common electrode line 4CL2 are structurally separated from each other. Additionally, in this implementation manner, the common electrode line 4CL1 is electrically connected to an alternating current common voltage Vcom1, and the common electrode line 4CL2 is electrically connected to an alternating current common voltage Vcom2.

From another perspective, in this implementation manner, the first shielding electrode 4LE1, the first common electrode 4CM1, and the third shielding electrode 4LE3 are a continuous conductive pattern, and therefore the first shielding electrode 4LE1 and the third shielding electrode 4LE3 have the same material as the first common electrode 4CM1; the second shielding electrode 4LE2 and the second common electrode 4CM2 are a continuous conductive pattern, and therefore the second shielding electrode 4LE2 has the same material as the second common electrode 4CM2. In other words, in this implementation manner, the shielding electrode layer 410 including the first shielding electrode 4LE1, the second shielding electrode 4LE2, and the third shielding electrode 4LE3 is also disposed above the inter-layer insulation layer IL.

It should be noted that, as discussed above, in the liquid crystal display panel in this implementation manner, the shielding electrode layer 410 that overlaps with the first data line DL1, the second data line DL2, and the third data line DL3 and receives a common voltage is disposed; therefore, a light leakage problem caused when data voltages on the first data line DL1, the second data line DL2, and the third data line DL3 affect negative liquid crystal molecules (not shown) in a negative liquid crystal layer 130 is avoided.

It should be described that, for the liquid crystal display panel in this implementation manner, by means of the architecture shown in FIG. 8 and FIG. 9, when a first pixel structure PS1 and a second pixel structure PS2 are switched to zero grayscale, an electric field is respectively generated between the first pixel electrode 4PE1 and the shielding electrode layer 410, and between the second pixel electrode 4PE2 and the shielding electrode layer 410. Specifically, referring to FIG. 9, in this implementation manner, an electric field F is generated between the first pixel electrode 4PE1 and the second shielding electrode 4LE2, and an electric field F is generated between the second pixel electrode 4PE2 and the third shielding electrode 4LE3. Further specifically, the electric field F has electric field directions of the first direction D1 and a third direction D3.

For example, referring to FIG. 9, in an implementation manner, when the first pixel structure PS1 and the second pixel structure PS2 are switched to zero grayscale, the first pixel electrode 4PE1 receives a negative-polarity voltage of 5.5 V, the second pixel electrode 4PE2 receives a positive-polarity voltage of 0.5 V, the first common electrode 4CM1 receives a common voltage of 6 V, and the second common electrode 4CM2 and a second shielding electrode LE2 receive a common voltage of 0 V, an electric field F is generated between the first pixel electrode 4PE1 on which the voltage is 5.5 V and the second shielding electrode 4LE2 on which the voltage is 0 V.

However, it should be further described that, although when the first pixel structure PS1 and the second pixel structure PS2 are switched to zero grayscale, an electric field F is respectively generated between the first pixel electrode 4PE1 and the second shielding electrode 4LE2, and between the second pixel electrode 4PE2 and the third shielding electrode 4LE3, the electric field F cannot affect the negative liquid crystal molecules (not shown) in the negative liquid crystal layer 130, and therefore an unexpected twist does not occur; the reason is as follows. As discussed above, when the first pixel structure PS1 and the second pixel structure PS2 are switched to zero grayscale (that is, the negative liquid crystal molecules are not driven by an electric field), the negative liquid crystal molecules are kept in an arrangement state in which long axes are substantially parallel to a second direction D2, and two short axes of the negative liquid crystal molecules in this state are respectively parallel to the first direction D1 and the third direction D3, that is, two short axes of the negative liquid crystal molecules are respectively parallel to an electric field direction of the electric field F. Therefore, in this case, the negative liquid crystal molecules absolutely do not twist due to the electric field F. In such a manner, the liquid crystal display panel in this implementation manner does not have a light leakage problem.

For the liquid crystal display panel in this implementation manner, as discussed above, when the first pixel structure PS1 and the second pixel structure PS2 are switched to zero grayscale, in addition to alignment forces provided by a first alignment film 140a and a second alignment film 140b, the electric field F respectively generated between the first pixel electrode 4PE1 and the second shielding electrode 4LE2, and between the second pixel electrode 4PE2 and the third shielding electrode 4LE3 also enables the negative liquid crystal molecules to be arranged along alignment directions of the first alignment film 140a and the second alignment film 140b.

That is, in this implementation manner, the shielding electrode layer 410 includes the first shielding electrode 4LE1, the second shielding electrode 4LE2, and the third shielding electrode 4LE3 that are disposed corresponding to the first data line DL1, the second data line DL2, and the third data line DL3. When the first pixel structure PS1 and the second pixel structure PS2 are switched to zero grayscale, the electric field F respectively generated between the first pixel electrode 4PE1 and the shielding electrode layer 410 and between the second pixel electrode 4PE2 and the shielding electrode layer 410 does not cause a light leakage problem, and instead, helps negative liquid crystal molecules on edges, near the second shielding electrode 4LE2, of the first pixel electrode 4PE1 and negative liquid crystal molecules on edges, near the third shielding electrode 4LE3, of the second pixel electrode 4PE2 twist back to an initial state, thereby improving a response speed and reducing a response time.

Additionally, as discussed above, for the liquid crystal display panel in this implementation manner, a driving manner of common voltage swing is used, and therefore, a logic power of the liquid crystal display panel can be reduced. However, it should be similarly described that, when a same logic power is used, as compared with a conventional liquid crystal display panel in which the driving manner of common voltage swing is not used, enable voltages equivalently perceived by the negative liquid crystal molecules in the liquid crystal display panel in this implementation manner are relatively high, and therefore, negative liquid crystal molecules having relatively low viscosity can be selected to improve a response speed and reduce a response time. That is, the liquid crystal display panel in this implementation manner can release liquid crystal parameters by using a suitable logic power to achieve objectives of improving a response speed and reducing a response time, and offset a disadvantage that the negative liquid crystal molecules have a long response time.

In conclusion, in this implementation manner, the liquid crystal display panel is an FFS negative liquid crystal display panel, a first pixel structure PS1 and a second pixel structure PS2 are configured to have different polarities, a first common electrode 4CM1 and a second common electrode 4CM2 are configured to be provided with different voltages, the first common electrode 4CM1 and the second common electrode 4CM2 have a configuration in the shape of the symbol “=”, a shielding electrode layer 410 overlaps with a first data line DL1, a second data line DL2 and a third data line DL3, and alignment directions of a first alignment film 140a and a second alignment film 140b are substantially perpendicular to an extending direction of a scan line SL, so that the liquid crystal display panel can at the same time have advantages of low logic power, fast response speed, and no light leakage problem.

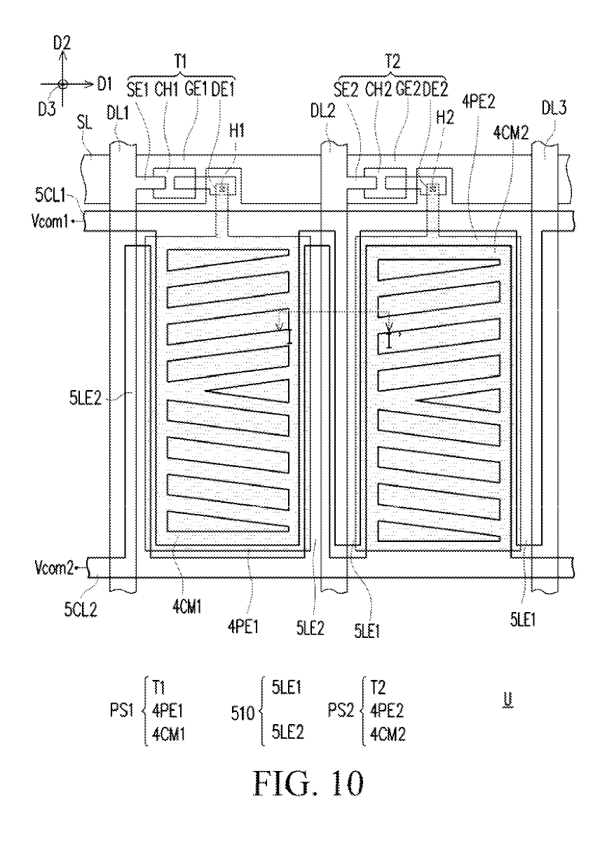

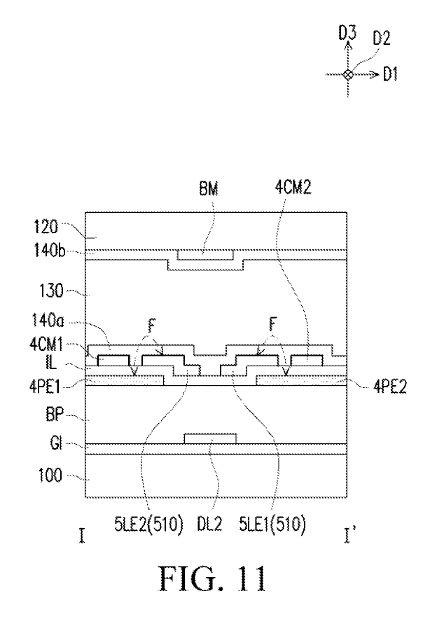

FIG. 10 is a schematic top view of a liquid crystal display panel according to a second implementation manner of the present invention. FIG. 11 is a schematic sectional view along a sectional line I-I′ in FIG. 10. Referring to both FIG. 10 and FIG. 8, the liquid crystal display panel in FIG. 10 and the liquid crystal display panel in FIG. 8 are similar, and therefore the same or similar elements are represented by using the same or similar symbols. Differences between the two are described below, and for what are the same of the two, reference may be made to the foregoing description according to the symbols in FIG. 1 and FIG. 2.

Referring to both FIG. 10 and FIG. 11, a shielding electrode layer 510 includes two first shielding electrodes 5LE1 and two second shielding electrodes 5LE2, where the two first shielding electrodes 5LE1 are respectively disposed on two sides of a second common electrode 4CM2 and are respectively overlapped with a second data line DL2 and a third data line DL3, and the two second shielding electrodes 5LE2 are respectively disposed on two sides of a first common electrode 4CM1 and are respectively overlapped with a first data line DL1 and the second data line DL2. That is, in this implementation manner, the shielding electrode layer 510 corresponds to the first data line DL1, the second data line DL2, and the third data line DL3, and overlaps with the first data line DL1, the second data line DL2, and the third data line DL3.

Additionally, in this implementation manner, the two first shielding electrodes 5LE1 and the first common electrode 4CM1 are connected to each other to form a common electrode line 5CL1, whereas the two second shielding electrodes 5LE2 and the second common electrode 4CM2 are connected to each other to form a common electrode line 5CL2. That is, in this implementation manner, the first shielding electrode 5LE1 and the first common electrode 4CM1 are configured to be provided with a same voltage, and the second shielding electrode 5LE2 and the second common electrode 4CM2 are configured to be provided with a same voltage. Furthermore, as discussed above, because the first common electrode 4CM1 and the second common electrode 4CM2 are configured to be provided with different voltages, the common electrode line 5CL1 and the common electrode line 5CL2 are also configured to be provided with different voltages, and the common electrode line 5CL1 and the common electrode line 5CL2 are structurally separated from each other. Additionally, in this implementation manner, the common electrode line 5CL1 is electrically connected to an alternating current common voltage Vcom1, and the common electrode line 5CL2 is electrically connected to an alternating current common voltage Vcom2.

From another perspective, in this implementation manner, the two first shielding electrodes 5LE1 and the first common electrode 4CM1 are a continuous conductive pattern, and therefore the first shielding electrodes 5LE1 have the same material as the first common electrode 4CM1; the two second shielding electrodes 5LE2 and the second common electrode 4CM2 are a continuous conductive pattern, and therefore the second shielding electrodes 2LE2 have the same material as the second common electrode 4CM2.

It should be noted that, as discussed above, in the liquid crystal display panel in this implementation manner, the shielding electrode layer 510 that overlaps with the first data line DL1, the second data line DL2, and the third data line DL3 and receives a common voltage is disposed; therefore, a light leakage problem caused when data voltages on the first data line DL1, the second data line DL2, and the third data line DL3 affect negative liquid crystal molecules (not shown) in a negative liquid crystal layer 130 is avoided.

Additionally, it should be described that, for the liquid crystal display panel in this implementation manner, by means of the architecture shown in FIG. 10 and FIG. 11, when a first pixel structure PS1 and a second pixel structure PS2 are switched to zero grayscale, an electric field is respectively generated between a first pixel electrode 4PE1 and the shielding electrode layer 510 and between a second pixel electrode 4PE2 and the shielding electrode layer 510. Specifically, referring to FIG. 11, in this implementation manner, an electric field F is respectively generated between the first pixel electrode 4PE1 and both the second shielding electrodes 5LE2 disposed on two sides of the first common electrode 4CM1, and an electric field F is respectively generated between the second pixel electrode 4PE2 and both the first shielding electrodes 5LE1 disposed on two sides of the second common electrode 4CM2. Further specifically, the electric field F has electric field directions of a first direction D1 and a third direction D3.

For example, referring to FIG. 11, in an implementation manner, when the first pixel structure PS1 and the second pixel structure PS2 are switched to zero grayscale, the first pixel electrode 4PE1 receives a negative-polarity voltage of 5.5 V, the second pixel electrode 4PE2 receives a positive-polarity voltage of 0.5 V, a first common electrode 4CM1 and the first shielding electrode 5LE1 receive a common voltage of 6 V, and the second common electrode 4CM2 and the second shielding electrode 5LE2 receive a common voltage of 0 V, an electric field F is generated between the first pixel electrode 4PE1 on which the voltage is 5.5 V and the second shielding electrode 5LE2 on which the voltage is 0 V, and an electric field F is generated between the second pixel electrode 4PE2 on which the voltage is 0.5 V and the first shielding electrode 5LE1 on which the voltage is 6 V.

However, it should be further described that, although when the first pixel structure PS1 and the second pixel structure PS2 are switched to zero grayscale, an electric field F is respectively generated between the first pixel electrode 4PE1 and second shielding electrode 5LE2 and between the second pixel electrode 4PE2 and first shielding electrode 5LE1, the electric field F cannot affect the negative liquid crystal molecules (not shown) in the negative liquid crystal layer 130, and therefore an unexpected twist does not occur; the reason is as follows. As discussed above, when the first pixel structure PS1 and the second pixel structure PS2 are switched to zero grayscale (that is, the negative liquid crystal molecules are not driven by an electric field), the negative liquid crystal molecules are kept in an arrangement state in which long axes are substantially parallel to a second direction D2, and two short axes of the negative liquid crystal molecules in this state are respectively parallel to the first direction D1 and the third direction D3, that is, two short axes of the negative liquid crystal molecules are respectively parallel to an electric field direction of the electric field F. Therefore, the negative liquid crystal molecules absolutely do not twist due to the electric field F. In such a manner, the liquid crystal display panel in this implementation manner does not have a light leakage problem.

For the liquid crystal display panel in this implementation manner, as discussed above, when the first pixel structure PS1 and the second pixel structure PS2 are switched to zero grayscale, in addition to alignment forces provided by a first alignment film 140a and a second alignment film 140b, an electric field F respectively generated between the first pixel electrode 4PE1 and the second shielding electrode 5LE2, and between the second pixel electrode 4PE2 and the first shielding electrode 5LE1 also enables the negative liquid crystal molecules to be arranged along alignment directions of the first alignment film 140a and the second alignment film 140b.

That is, in this implementation manner, the shielding electrode layer 510 includes the two second shielding electrodes 5LE2 disposed corresponding to the first data line DL1 and the second data line DL2 on two sides of the first pixel electrode 4PE1, and the two first shielding electrodes 5LE1 disposed corresponding to the second data line DL2 and the third data line DL3 on two sides of the second pixel electrode 4PE2. When the first pixel structure PS1 and the second pixel structure PS2 are switched to zero grayscale, the electric field F respectively generated between the first pixel electrode 4PE1 and the shielding electrode layer 510, and between the second pixel electrode 4PE2 and the shielding electrode layer 510 does not cause a light leakage problem, and instead, helps negative liquid crystal molecules on two edges, near the second shielding electrode 5LE2, of the first pixel electrode 4PE1 and negative liquid crystal molecules on two edges, near the first shielding electrode 5LE1, of the second pixel electrode 4PE2 twist back to an initial state, thereby improving a response speed and reducing a response time.

Additionally, as discussed above, for the liquid crystal display panel in this implementation manner, a driving manner of common voltage swing is used, and therefore, a logic power of the liquid crystal display panel can be reduced. However, it should be similarly described that, when a same logic power is used, as compared with a conventional liquid crystal display panel in which the driving manner of common voltage swing is not used, enable voltages equivalently perceived by the negative liquid crystal molecules in the liquid crystal display panel in this implementation manner are relatively high, and therefore, negative liquid crystal molecules having relatively low viscosity can be selected to improve a response speed and reduce a response time. That is, the liquid crystal display panel in this implementation manner can release liquid crystal parameters by using a suitable logic power to achieve objectives of improving a response speed and reducing a response time, and offset a disadvantage that the negative liquid crystal molecules have a long response time.

In conclusion, in this implementation manner, the liquid crystal display panel is an FFS negative liquid crystal display panel, a first pixel structure PS1 and a second pixel structure PS2 are configured to have different polarities, a first common electrode 4CM1 and a second common electrode 4CM2 are configured to be provided with different voltages, the first common electrode 4CM1 and the second common electrode 4CM2 have a configuration in the shape of the symbol “=”, a shielding electrode layer 510 overlaps with a first data line DL1, a second data line DL2 and a third data line DL3, and alignment directions of a first alignment film 140a and a second alignment film 140b are substantially perpendicular to an extending direction of a scan line SL, so that the liquid crystal display panel can at the same time have advantages of low logic power, a fast response speed, and no light leakage problem.

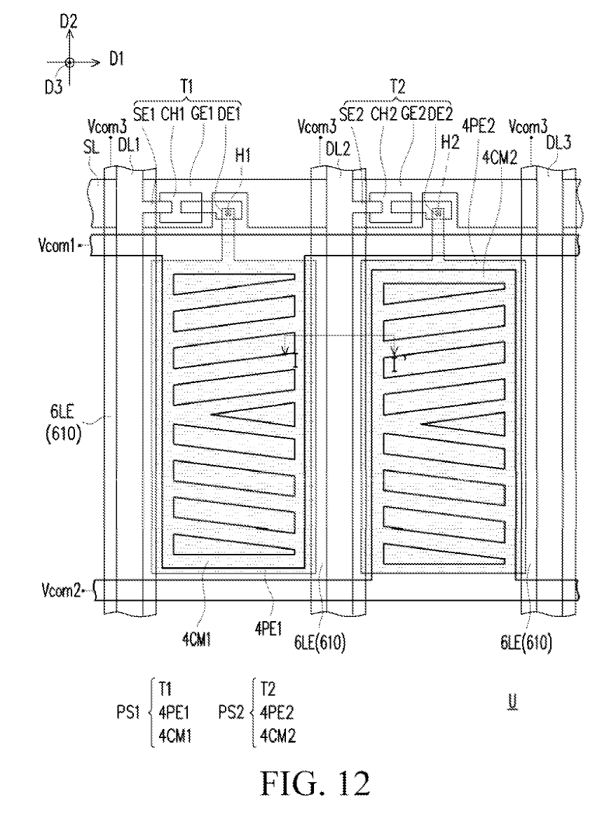

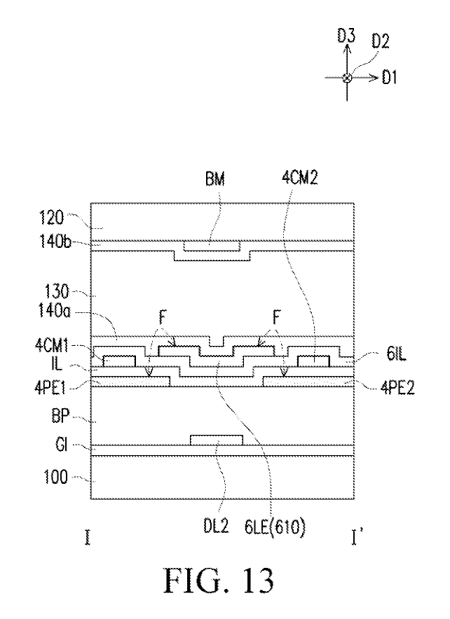

FIG. 12 is a schematic top view of a liquid crystal display panel according to a third implementation manner of the present invention. FIG. 13 is a schematic sectional view along a sectional line I-I′ in FIG. 12. Referring to both FIG. 12 and FIG. 8, the liquid crystal display panel in FIG. 12 and the liquid crystal display panel in FIG. 8 are similar, and therefore the same or similar elements are represented by using the same or similar symbols. Differences between the two are described below, and for what are the same of the two, reference may be made to the foregoing description according to the symbols in FIG. 1 and FIG. 2.

Referring to both FIG. 12 and FIG. 13, a shielding electrode layer 610 includes multiple shielding electrodes 6LE, and the shielding electrodes 6LE are respectively overlapped with a first data line DL1, a second data line DL2 and a third data line DL3. That is, in this implementation manner, the shielding electrode layer 610 corresponds to the first data line DL1, the second data line DL2, and the third data line DL3, and overlaps with the first data line DL1, the second data line DL2, and the third data line DL3. Additionally, the shielding electrode layer 610 is, for example, a transparent conductive layer, and a material of the shielding electrode layer 310 includes a metal oxide conductive material, for example, indium tin oxide, indium zinc oxide, aluminum tin oxide, aluminum zinc oxide, indium germanium zinc oxide, or another suitable oxide, or a stacked layer of at least two above.

In this implementation manner, the shielding electrodes 6LE are structurally separated from a first common electrode 4CM1 and a second common electrode 4CM2. Specifically, in this implementation manner, an inter-layer insulation layer 6IL is further respectively disposed between the shielding electrode 6LE and the first common electrode 4CM1 and between the shielding electrode 6LE and the second common electrode 4CM2, so that the shielding electrodes 6LE are structurally separated from the first common electrode 4CM1 and the second common electrode 4CM2.

Additionally, in this implementation manner, the shielding electrodes 6LE, the first common electrode 4CM1, and the second common electrode 4CM2 are configured to be provided with different voltages, and the voltages on the shielding electrode 6LE are between the voltage on the first common electrode 4CM1 and the voltage on the second common electrode 4CM2. That is, in this implementation manner, the voltage on the shielding electrode 6LE, the voltage on the first common electrode 4CM1, and the voltage on the second common electrode 4CM2 are all different from each other. For example, in an implementation manner, the voltage on the first common electrode 4CM1 is 6 V, the voltage on the second common electrode 4CM2 is 0 V, and the voltage on the shielding electrode 6LE is 3 V. From another perspective, in this implementation manner, the first common electrode 4CM1 is electrically connected to an alternating current common voltage Vcom1, the second common electrode 4CM2 is electrically connected to an alternating current common voltage Vcom2, and the shielding electrode 6LE is electrically connected to a direct current common voltage Vcom3, where the alternating current common voltage Vcom1, the alternating current common voltage Vcom2, and the direct current common voltage Vcom3 are all different from each other.

It should be noted that, as discussed above, in the liquid crystal display panel in this implementation manner, the shielding electrode layer 610 that overlaps with the first data line DL1, the second data line DL2, and the third data line DL3 and receives the direct current common voltage Vcom3 is disposed; therefore, a light leakage problem caused when data voltages on the first data line DL1, the second data line DL2, and the third data line DL3 affect negative liquid crystal molecules (not shown) in a negative liquid crystal layer 130 is avoided.

It should be described that, for the liquid crystal display panel in this implementation manner, by means of the architecture shown in FIG. 12 and FIG. 13, when a first pixel structure PS1 and a second pixel structure PS2 are switched to zero grayscale, an electric field is generated respectively between a first pixel electrode 4PE1 and the shielding electrode layer 610 and between a second pixel electrode 4PE2 and the shielding electrode layer 610. Specifically, referring to FIG. 13, in this implementation manner, an electric field F is generated respectively between each shielding electrode 6LE and the adjacent first pixel electrode 4PE1 and second pixel electrode 4PE2. Further specifically, the electric field F has electric field directions of a first direction D1 and a third direction D3.

For example, referring to FIG. 13, in an implementation manner, when the first pixel structure PS1 and the second pixel structure PS2 are switched to zero grayscale, the first pixel electrode 4PE1 receives a negative-polarity voltage of 5.5 V, the second pixel electrode 4PE2 receives a positive-polarity voltage of 0.5 V, the first common electrode 4CM1 receives a common voltage of 6 V, the second common electrode 4CM2 receives a common voltage of 0 V and the shielding electrode 6LE receive a common voltage of 3 V, an electric field F is generated between the first pixel electrode 4PE1 on which the voltage is 5.5 V and the shielding electrode 6LE on which the voltage is 3 V, and an electric field F is also generated between the second pixel electrode 4PE2 on which the voltage is 0.5 V and the shielding electrode 6LE on which the voltage is 3 V.

However, it should be further described that, although when the first pixel structure PS1 and the second pixel structure PS2 are switched to zero grayscale, an electric field F is generated respectively between each shielding electrode 6LE and the adjacent first pixel electrode 4PE1 and second pixel electrode 4PE2, the electric field F cannot affect the negative liquid crystal molecules (not shown) in the negative liquid crystal layer 130, and therefore an unexpected twist does not occur; the reason is as follows. As discussed above, when the first pixel structure PS1 and the second pixel structure PS2 are switched to zero grayscale (that is, the negative liquid crystal molecules are not driven by an electric field), the negative liquid crystal molecules are kept in an arrangement state in which long axes are substantially parallel to a second direction D2, and two short axes of the negative liquid crystal molecules in this state are respectively parallel to the first direction D1 and the third direction D3, that is, two short axes of the negative liquid crystal molecules are respectively parallel to an electric field direction of an electric field F. Therefore, the negative liquid crystal molecules absolutely do not twist due to the electric field F. In such a manner, the liquid crystal display panel in this implementation manner does not have a light leakage problem.

For the liquid crystal display panel in this implementation manner, as discussed above, when the first pixel structure PS1 and the second pixel structure PS2 are switched to zero grayscale, in addition to alignment forces provided by a first alignment film 140a and a second alignment film 140b, an electric field F respectively generated between the shielding electrode 6LE and the first pixel electrode 4PE1, and between the shielding electrode 6LE and the second pixel electrode 4PE2 also enables the negative liquid crystal molecules to be arranged along alignment directions of the first alignment film 140a and the second alignment film 140b.

That is, in this implementation manner, the shielding electrode layer 610 includes the shielding electrodes 6LE additionally disposed corresponding to the first data line DL1, the second data line DL2, and the third data line DL3. When the first pixel structure PS1 and the second pixel structure PS2 are switched to zero grayscale, the electric field F respectively generated between the shielding electrode 6LE and the first pixel electrode 4PE1 and between the shielding electrode 6LE and the second pixel electrode 4PE2 does not cause a light leakage problem, and instead, helps negative liquid crystal molecules on two edges, near the shielding electrode 6LE, of the first pixel electrode 4PE1 and negative liquid crystal molecules on two edges, near the shielding electrode 6LE, of the second pixel electrode 4PE2 twist back to an initial state, thereby improving a response speed and reducing a response time.

Additionally, as discussed above, for the liquid crystal display panel in this implementation manner, a driving manner of common voltage swing is used, and therefore, a logic power of the liquid crystal display panel can be reduced. However, it should be similarly described that, when a same logic power is used, as compared with a conventional liquid crystal display panel in which the driving manner of common voltage swing is not used, enable voltages equivalently perceived by the negative liquid crystal molecules in the liquid crystal display panel in this implementation manner are relatively high, and therefore, negative liquid crystal molecules having relatively low viscosity can be selected to improve a response speed and reduce a response time. That is, the liquid crystal display panel in this implementation manner can release liquid crystal parameters by using a suitable logic power to achieve objectives of improving a response speed and reducing a response time, and offset a disadvantage that the negative liquid crystal molecules have a long response time.

In conclusion, in this implementation manner, the liquid crystal display panel is an FFS negative liquid crystal display panel, a first pixel structure PS1 and a second pixel structure PS2 are configured to have different polarities, a first common electrode 4CM1 and a second common electrode 4CM2 are configured to be provided with different voltages, the first common electrode 4CM1 and the second common electrode 4CM2 have a configuration in the shape of the symbol “=”, a shielding electrode layer 610 overlaps with a first data line DL1, a second data line DL2 and a third data line DL3, and alignment directions of a first alignment film 140a and a second alignment film 140b are substantially perpendicular to an extending direction of a scan line SL, so that the liquid crystal display panel can at the same time have advantages of low logic power, fast response speed, and no light leakage problem.

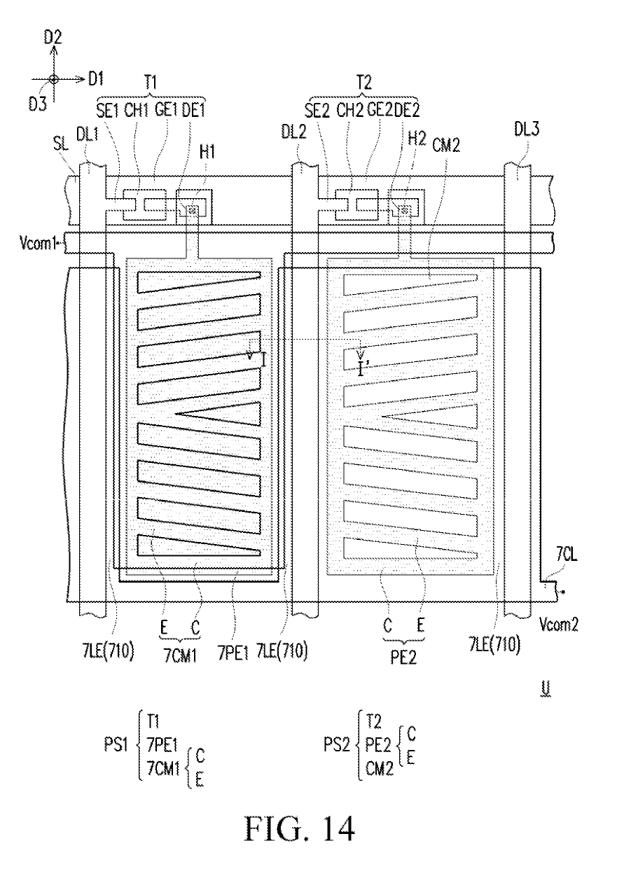

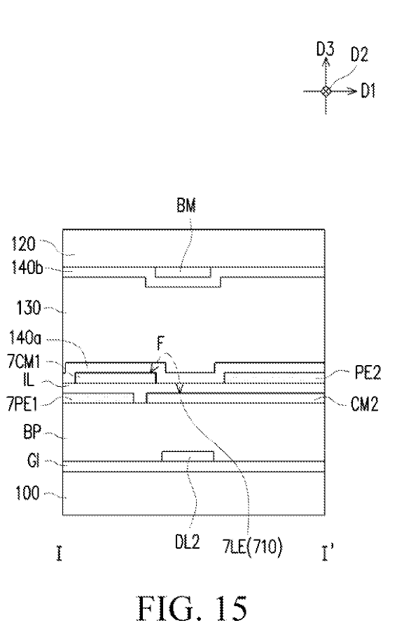

Additionally, in the first to third implementation manners above, the first pixel electrode PE1 and the second pixel electrode PE2 both have a configuration in the shape of the symbol “=”, and in the fourth to sixth implementation manners above, the first common electrode 4CM1 and the second common electrode 4CM2 both have a configuration in the shape of the symbol “=”. However, the present invention is not limited thereto, and as long as one of the first pixel electrode and first common electrode and one of the second pixel electrode and the second common electrode respectively include a frame and multiple strip electrodes, such a case falls within the scope of the present invention. Next, detailed description is provided below with reference to FIG. 14 and FIG. 15.

FIG. 14 is a schematic top view of a liquid crystal display panel according to a seventh implementation manner of the present invention. FIG. 15 is a schematic sectional view along a sectional line I-I′ in FIG. 14. Referring to both FIG. 14 and FIG. 1, the liquid crystal display panel in FIG. 14 and the liquid crystal display panel in FIG. 1 are similar, and therefore the same or similar elements are represented by using the same or similar symbols. Differences between the two are described below, and for what are the same of the two, reference may be made to the foregoing description according to the symbols in FIG. 1 and FIG. 2.

Referring to both FIG. 14 and FIG. 15, in this implementation manner, a first pixel electrode 7PE1 is an electrode having a block-form pattern, and a first common electrode 7CM1 includes a frame C and multiple strip electrodes E. That is, in this implementation manner, the first common electrode 7CM1 and a second pixel electrode PE2 both have a layout design in the shape of the symbol “=”, and the first pixel electrode 7PE1 and a second common electrode CM2 are electrodes having a block-form pattern.

From another perspective, referring to both FIG. 15, in this implementation manner, the first common electrode 7CM1 is located above an inter-layer insulation layer IL, and the first pixel electrode 7PE1 is correspondingly disposed below the first common electrode 7CM1. The second pixel electrode PE2 is located above the inter-layer insulation layer IL, and the second common electrode CM2 is correspondingly disposed below the second pixel electrode PE2. That is, as discussed in the first implementation manner, in this implementation manner, when the liquid crystal display panel is in a display state, an edge electric field whose electric field direction is substantially perpendicular to a first direction D1 is respectively generated between the first common electrode 7CM1 and the first pixel electrode 7PE1 and between the second common electrode CM2 and the second pixel electrode PE2.

Additionally, in this implementation manner, a shielding electrode layer 710 includes multiple shielding electrodes 7LE, and the shielding electrodes 7LE are respectively overlapped with a first data line DL1, a second data line DL2, and a third data line DL3. That is, in this implementation manner, the shielding electrode layer 710 corresponds to the first data line DL1, the second data line DL2, and the third data line DL3, and overlaps with the first data line DL1, the second data line DL2, and the third data line DL3.

Specifically, in this implementation manner, the shielding electrodes 7LE and the second common electrode CM2 are connected to each other to form a common electrode line 7CL. That is, in this implementation manner, the shielding electrodes 7LE and the second common electrode CM2 are configured to be provided with a same voltage. Furthermore, as discussed in the first implementation manner, because the first common electrodes 7CM1 and the second common electrode CM2 are configured to be provided with different voltages, the common electrode line 7CL is structurally separated from the first common electrode 7CM1. Additionally, in this implementation manner, the first common electrode 7CM1 is electrically connected to an alternating current common voltage Vcom1, and the common electrode line 7CL is electrically connected to an alternating current common voltage Vcom2.

From another perspective, in this implementation manner, the shielding electrodes 7LE and the second common electrode CM2 are a continuous conductive pattern, so that the shielding electrodes 7LE have the same material as the second common electrode CM2. Additionally, in this implementation manner, the first common electrode 7CM1 is, for example, a transparent conductive layer, and a material of the first common electrode 7CM1 is includes a metal oxide conductive material, for example, indium tin oxide, indium zinc oxide, aluminum tin oxide, aluminum zinc oxide, indium germanium zinc oxide, or another suitable oxide, or a stacked layer of at least two above.

It should be noted that, as discussed above, in the liquid crystal display panel in this implementation manner, the shielding electrode layer 710 that overlaps with the first data line DL1, the second data line DL2, and the third data line DL3 and receives a common voltage is disposed; therefore, a light leakage problem caused when data voltages on the first data line DL1, the second data line DL2, and the third data line DL3 affect negative liquid crystal molecules (not shown) in a negative liquid crystal layer 130 is avoided.

Additionally, it should be described that, for the liquid crystal display panel in this implementation manner, by means of the architecture shown in FIG. 14 and FIG. 15, when a first pixel structure PS1 and a second pixel structure PS2 are switched to zero grayscale, an electric field is generated between the first common electrode 7CM1 and the shielding electrode layer 710. Specifically, referring to both FIG. 14 and FIG. 15, in this implementation manner, an electric field F is respectively generated between the first common electrode 7CM1 and the adjacent shielding electrodes 7LE. Further specifically, the electric field F has electric field directions of the first direction D1 and a third direction D3.

For example, referring to FIG. 14 and FIG. 15, in an implementation manner, when the first pixel structure PS1 and the second pixel structure PS2 are switched to zero grayscale, the first pixel electrode 7PE1 receives a negative-polarity voltage of 5.5 V, the second pixel electrode PE2 receives a positive-polarity voltage of 0.5 V, the first common electrode 7CM1 receives a common voltage of 6 V, and the second common electrode CM2 and the shielding electrode 7LE receive a common voltage of 0 V, an electric field F is generated between the shielding electrode 7LE on which the voltage is 0 V and the first common electrode 7CM1 on which the voltage is 6 V.

However, it should be further described that, although when the first pixel structure PS1 and the second pixel structure PS2 are switched to zero grayscale, an electric field F is generated between the first common electrode 7CM1 and the adjacent shielding electrode 7LE, the electric field F cannot affect the negative liquid crystal molecules (not shown) in the negative liquid crystal layer 130, and therefore an unexpected twist does not occur; the reason is as follows. As discussed above, when the first pixel structure PS1 and the second pixel structure PS2 are switched to zero grayscale (that is, the negative liquid crystal molecules are not driven by an electric field), the negative liquid crystal molecules are kept in an arrangement state in which long axes are substantially parallel to a second direction D2, and two short axes of the negative liquid crystal molecules in this state are respectively parallel to the first direction D1 and the third direction D3, that is, two short axes of the negative liquid crystal molecules are respectively parallel to an electric field direction of the electric field F. Therefore, the negative liquid crystal molecules absolutely do not twist due to the electric field F. In such a manner, the liquid crystal display panel in this implementation manner does not have a light leakage problem.

For the liquid crystal display panel in this implementation manner, as discussed above, when the first pixel structure PS1 and the second pixel structure PS2 are switched to zero grayscale, in addition to alignment forces provided by a first alignment film 140a and a second alignment film 140b, the electric field F generated between the first common electrode 7CM1 and the adjacent shielding electrode 7LE also enables the negative liquid crystal molecules to be arranged along alignment directions of the first alignment film 140a and the second alignment film 140b.

That is, in this implementation manner, the shielding electrode layer 710 includes the shielding electrodes 7LE disposed corresponding to the first data line DL1, the second data line DL2, and the third data line DL3. When the first pixel structure PS1 and the second pixel structure PS2 are switched to zero grayscale, the electric field F respectively generated between the first common electrode 7CM1 and the adjacent shielding electrodes 7LE does not cause a light leakage problem, and instead, helps negative liquid crystal molecules on two edges, near the shielding electrode 7LE, of the first common electrode 7CM1 twist back to an initial state, thereby improving a response speed and reducing a response time.

Additionally, as discussed above, for the liquid crystal display panel in this implementation manner, a driving manner of common voltage swing is used, and therefore, a logic power of the liquid crystal display panel can be reduced. However, it should be similarly described that, when a same logic power is used, as compared with a conventional liquid crystal display panel in which the driving manner of common voltage swing is not used, enable voltages equivalently perceived by the negative liquid crystal molecules in the liquid crystal display panel in this implementation manner are relatively high, and therefore, negative liquid crystal molecules having relatively low viscosity can be selected to improve a response speed and reduce a response time. That is, the liquid crystal display panel in this implementation manner can release liquid crystal parameters by using a suitable logic power to achieve objectives of improving a response speed and reducing a response time, and offset a disadvantage that the negative liquid crystal molecules have a long response time.

In conclusion, in this implementation manner, the liquid crystal display panel is an FFS negative liquid crystal display panel, a first pixel structure PS1 and a second pixel structure PS2 are configured to have different polarities, a first common electrode 7CM1 and a second common electrode CM2 are configured to be provided with different voltages, the first common electrode 7CM1 and the second pixel electrode PE2 have a configuration in the shape of the symbol “=”, a shielding electrode layer 710 overlaps with a first data line DL1, a second data line DL2 and a third data line DL3, and alignment directions of a first alignment film 140a and a second alignment film 140b are substantially perpendicular to an extending direction of a scan line SL, so that the liquid crystal display panel can at the same time have advantages of a low logic power, a fast response speed, and no light leakage problem.

Although the present invention is disclosed as above by using the implementation manners, the implementation manners are not used to limit the present invention. Any person skilled in the art may make various variations and modifications without departing from the spirit and scope of the present invention, and therefore the protection scope of the present invention should be as defined by the appended claims.

What is claimed is:

1. A liquid crystal display panel, comprising: a plurality of pixel units, at least one pixel unit of the pixel units comprising:
a first substrate;
a scan line, a first data line, a second data line, and a third data line, disposed on the first substrate;
a first pixel structure, located between the first data line and the second data line, and electrically connected to the scan line and the first data line, the first pixel structure comprising:
a first active device;
a first pixel electrode, electrically connected to the first active device; and
a first common electrode, structurally separated from the first pixel electrode;
a second pixel structure, located between the second data line and the third data line, and electrically connected to the scan line and the second data line, the second pixel structure and the first pixel structure being configured to have different polarities, and the second pixel structure comprising:
a second active device;
a second pixel electrode, electrically connected to the second active device; and
a second common electrode, structurally separated from the second pixel electrode, wherein the first common electrode and the second common electrode are configured to be provided with different voltages, and one of the first pixel electrode and the first common electrode and one of the second pixel electrode and the second common electrode respectively comprising:
a frame, having two sides disposed along an extending direction of the first data line and the second data line; and
two strip electrodes, two ends of each strip electrode being respectively connected to the two sides;
a shielding electrode layer, corresponding to the first data line, the second data line and the third data line, and overlapping with the first data line, the second data line and the third data line;
a second substrate, located opposite to the first substrate; and
a negative liquid crystal layer, disposed between the first substrate and the second substrate.

2. The liquid crystal display panel according to claim 1, further comprising a first alignment film and a second alignment film, the first alignment film being disposed on the first substrate, and located between the first substrate and the negative liquid crystal layer, and the second alignment film being disposed on the second substrate, and located between the second substrate and the negative liquid crystal layer, wherein an alignment direction of the first alignment film and an alignment direction of the second alignment film are substantially perpendicular to an extending direction of the scan line.

3. The liquid crystal display panel according to claim 1, further comprising an inter-layer insulation layer, located between the first common electrode and the first pixel electrode and located between the second common electrode and the second pixel electrode, wherein the first common electrode and the second common electrode are located above the inter-layer insulation layer, and the first common electrode and the second common electrode respectively comprise the strip electrodes.

4. The liquid crystal display panel according to claim 1, further comprising an inter-layer insulation layer, located between the first common electrode and the first pixel electrode and located between the second common electrode and the second pixel electrode, wherein the first pixel electrode and the second pixel electrode are located above the inter-layer insulation layer, and the first pixel electrode and the second pixel electrode respectively comprise the strip electrodes.

5. The liquid crystal display panel according to claim 1, further comprising an inter-layer insulation layer, located between the first common electrode and the first pixel electrode and located between the second common electrode and the second pixel electrode, wherein the first common electrode and the second pixel electrode are located above the inter-layer insulation layer, and the first common electrode and the second pixel electrode respectively comprise the strip electrodes.

6. The liquid crystal display panel according to claim 1, wherein the shielding electrode layer comprises a first shielding electrode and a second shielding electrode, and the first shielding electrode and the second shielding electrode are structurally separated.

7. The liquid crystal display panel according to claim 6, wherein the first shielding electrode is connected to the first common electrode and overlaps with the first data line, and the second shielding electrode is connected to the second common electrode and overlaps with the second data line.

8. The liquid crystal display panel according to claim 6, wherein the first shielding electrode and the first common electrode are configured to be provided with a same voltage, and the second shielding electrode and the second common electrode are configured to be provided with a same voltage.

9. The liquid crystal display panel according to claim 1, wherein the shielding electrode layer comprises two first shielding electrodes and two second shielding electrodes, and the first shielding electrodes and the second shielding electrodes are structurally separated.

10. The liquid crystal display panel according to claim 9, wherein the first shielding electrodes are respectively disposed on two sides of the second common electrode and respectively overlap with the second data line and the third data line, and the second shielding electrodes are respectively disposed on two sides of the first common electrode and respectively overlap with the first data line and the second data line.

11. The liquid crystal display panel according to claim 9, wherein the first shielding electrodes and the first common electrode are configured to be provided with a same voltage, and the second shielding electrodes and the second common electrode are configured to be provided with a same voltage.

12. The liquid crystal display panel according to claim 1, wherein the shielding electrode layer comprises a plurality of shielding electrodes, respectively overlapping with the first data line, the second data line and the third data line, and the shielding electrodes are separated from the first common electrode and the second common electrode.

13. The liquid crystal display panel according to claim 12, wherein the shielding electrodes, the first common electrode and the second common electrode are configured to be provided with different voltages, and the voltages on the shielding electrodes are between the voltage on the first common electrode and the voltage on the second common electrode.

14. The liquid crystal display panel according to claim 1, wherein the strip electrodes are linear strip electrodes.

15. The liquid crystal display panel according to claim 1, wherein each of the two strip electrodes has a bending portion and two connecting portions connected to the bending portion.

16. The liquid crystal display panel according to claim 1, wherein the strip electrodes comprise a first strip electrode and a second strip electrode, wherein an extending direction of the first strip electrode and an extending direction of the second strip electrode intersect with each other.
